(19) United States
(12) Patent Application Publication
(10) Pub. No.: US 2023/0286861 A1
(43) Pub. Date: Sep. 14, 2023

(54) DE-ICING COMPOSITIONS AND METHODS OF MAKING AND USING THEREOF

(71) Applicant: Compass Minerals America Inc., Overland Park, KS (US)

(72) Inventors: Suraj Deshmukh, Overland Park, KS (US); Geoff Brown, Overland Park, KS (US); Dan Pannell, Overland Park, KS (US); Amir Yaghoob Farnam, Philadelphia, PA (US); Robin Deb, Philadelphia, PA (US)

(21) Appl. No.: 18/181,471

(22) Filed: Mar. 9, 2023

Related U.S. Application Data
(60) Provisional application No. 63/269,100, filed on Mar. 9, 2022.

(51) Int. Cl. C04B 20/10; C09K 5/06; C04B 18/02; C04B 28/02

(52) U.S. Cl. CPC C04B 20/1025; C09K 5/066; C04B 18/027; C04B 28/02; C04B 2103/601

(57) ABSTRACT

The present disclosure is directed to phase change material compositions, low temperature applications for phase change materials, snow-melt applications for phase change materials, and deicing applications for phase change materials. In some embodiments, phase change materials comprise lightweight aggregates. In some embodiments, the low temperature and deicing applications include concrete applications.

### CROSS-REFERENCE TO RELATED APPLICATIONS

This application claims priority to U.S. Provisional Patent Application Ser. No. 63/269,100, filed on Mar. 9, 2022, the disclosure of which is hereby incorporated by reference in its entirety.

### FIELD OF THE DISCLOSURE

The field of the disclosure relates generally to melting snow, deicing, and low temperature treatment compositions and methods for porous surfaces.

### BACKGROUND OF THE DISCLOSURE

Deicing Salts. For snow-melting, deicing salts are sprayed on roads and concrete pavements and depress the freezing point of water. Chemical composition of salts may include, but are not limited to, sodium chloride (NaCl), calcium chloride (CaCl2), and magnesium chloride (MgCl2). Each chemical composition has a different effective melt temperature based on their eutectic temperature.

For example, sodium chloride has a eutectic temperature of about −6° F. and hence is typically very effective between about 15° F. to about 30° F. However, it's melting capacity decreases dramatically as it approaches its eutectic temperature of −6° F. As an example, 1 pound of salt may melt 46 pounds of ice at 30° F. but at 15° F. it may only melt about 6 pounds of ice. (See, https://www.clickondetroit.com/weather-center/2019/02/05/when-does-alt-work-and-when-does-it-not/). This makes salt less effective as temperatures plummet at night or cycle up and down due to snow and ice events. Hence, many times combinations of different deicers that have different eutectic temperatures are used to provide a synergistic melting performance for a wider temperature range. Despite use of mixtures, deicing mixture compositions are rendered ineffective when the temperatures change or cycle during normal day-night cycles.

Major Consequences. Some of the major consequences of deicing salts include concrete scaling and reinforcement corrosion. Concrete scaling refers to the general loss of surface mortar or mortar surrounding the coarse aggregate particles on a concrete surface. (See, https://www.cement.org/learn/concrete-technology/durability/prevent-scaling). Reinforcement corrosion refers to the corrosion of embedded metals (e.g., steel), which over a period of time, causes cracking, delamination, and spalling of the concrete. (See, https://www.cement.org/learn/concrete-technology/durability/corrosion-of-embedded-materials).

A damage mechanism results when chlorides+calcium hydroxide+water produce oxychlorides (an expansive product). Oxychlorides expand and damage the cementitious matrix of concrete surfaces.

Accordingly, there is a need for alternative, less damaging solutions to conventional deicing salts for snow-melting applications on porous surfaces.

### BRIEF DESCRIPTION OF THE DISCLOSURE

In various aspects, the present disclosure is directed to phase change material compositions, low temperature applications for phase change materials, snow-melt applications for phase change materials, and deicing applications for phase change materials. In some embodiments, phase change materials include lightweight aggregates. In some embodiments, the low temperature and deicing applications include concrete applications.

In one embodiment, a packaged phase change material for deicing may include a package defining an internal volume, and a deicing composition. The deicing composition may include a phase change material, and a deicing material. The phase change material may be incorporated with the deicing material in the amount of about 1% to about 99%. In some forms, the amount of phase change material incorporated with the deicing material is between 5% to about 80%, 7% to about 60%, 8 to about 55, 50, 45, 40, 35, 30, 25, 24, 23, 22, 21, 20, 19, 18, 17, 16, or 15%. In some instances the amount of phase change material is determined by the specific salt or deicing composition utilized. In some forms, the phase change material is present in an amount between 5% and 25, 20, or 15%. In some instances, the phase change material may be incorporated into the deicing composition as a granulated additive. In other instances, the phase change material may be coated onto the deicing material. The deicing composition may further include a lightweight aggregate that may be impregnated with the phase change material. In non-limiting examples, the package may be selected from the group including bags, totes, railcars, supersacks, and any combination thereof.

In some examples, the phase change material may be selected from the group including paraffins, non-paraffin organics (ethylene glycol, formic acid), salt hydrates (sodium sulfate decahydrate, Dowtherm), metallics, fused salt eutectics, solid-solid, n-tetradecane, n-hexadecane, n-octadecane, n-pentadecane, n-Eicosane, polyethylene glycol 600, acetic acid, tristearin, myristic acid, stearic acid, elaidic acid, acetamide, methyl fumarate, oxazoline wax—TS-970, oxazoline wax—ES-254, sodium hydrogen phosphate dodecahydrate, lithium nitrate trihydrate, barium hydroxide octahydrate, and any combination thereof.

In some embodiments, the deicer material may be selected from the group including sodium chloride, calcium chloride, urea, magnesium chloride, potassium sulfate, lignin sulfonate, sodium sulfate, sodium silicates, NaCl, KCl, MgCl2, calcium magnesium acetate, and any combination thereof.

In some embodiments, the packaged phase change material for deicing may further include an anti-caking agent. The anti-caking agent may be selected from the group including sodium aluminosilicate, sodium ferrocyanide, potassium ferrocyanide, calcium carbonate, magnesium carbonate, silicon dioxide (SiO2), stearates of calcium and magnesium, silica, talc, flour, starch, tricalcium phosphate, powdered cellulose, sodium bicarbonate, calcium ferrocyanide, calcium phosphate, sodium silicate, calcium silicate, magnesium trisilicate, potassium aluminum silicate, calcium aluminosilicate, bentonite, aluminum silicate, stearic acid, polydimethylsiloxane, and any combination thereof.

In some embodiments, the packaged phase change material for deicing may further include a salt melt trigger. The salt melt trigger may be selected from the group including inorganic salts (a carbonate or an additional chloride such as potassium carbonate, lithium chloride, or magnesium chloride hexahydrate), an organic compound containing an ether group or a hydroxyl group, compounds with groups selected from the group consisting of saccharides, alcohols, glycols and glucosides, and any mixture or combination of the foregoing.

In another embodiment, a concrete mixture may include a percentage of cement, a percentage of lightweight aggregate, a percentage of water, and a percentage of phase change material. The lightweight aggregate may be impregnated with a percentage of the phase change material. The phase change material may be incorporated with the lightweight aggregate in the amount of about 1% to about 99%. In some forms, the amount of phase change material incorporated with the deicing material is between 5% to about 80%, 7% to about 60%, 8 to about 55, 50, 45, 40, 35, 30, 25, 24, 23, 22, 21, 20, 19, 18, 17, 16, or 15%. In some instances the amount of phase change material is determined by the specific salt or deicing composition utilized. In some forms, the phase change material is present in an amount between 5% and 25, 20, or 15%. The phase change material may be configured to release stored energy as the phase change material begins to freeze, thereby heating a surface. The phase change material may be configured to leach a percentage of the phase change material into the concrete mixture when the concrete mixture is cured, thereby forming a thin coating on a surface of the cured concrete mixture.

In some instances, the phase change material may be selected from the group including paraffins, non-paraffin organics (ethylene glycol, formic acid), salt hydrates (sodium sulfate decahydrate, Dowtherm), metallics, fused salt eutectics, solid-solid, n-tetradecane, n-hexadecane, n-octadecane, n-pentadecane, n-Eicosane, polyethylene glycol 600, acetic acid, tristearin, myristic acid, stearic acid, elaidic acid, acetamide, methyl fumarate, oxazoline wax—TS-970, oxazoline wax—ES-254, sodium hydrogen phosphate dodecahydrate, lithium nitrate trihydrate, barium hydroxide octahydrate, and any combination thereof.

In another embodiment, a method of applying a deicing composition includes applying the deicing composition to a porous surface, such that the deicing composition is configured to release stored energy as the phase change material begins to freeze. The deicing composition may include a phase change material, and a deicing material. The phase change material may be configured to leach a percentage of the phase change material into the porous surface to form a thin coating and repel water. The phase change material may be incorporated with the deicing material in the amount of about 1% to about 99%. In some forms, the amount of phase change material incorporated with the deicing material is between 5% to about 80%, 7% to about 60%, 8 to about 55, 50, 45, 40, 35, 30, 25, 24, 23, 22, 21, 20, 19, 18, 17, 16, or 15%. In some instances the amount of phase change material is determined by the specific salt or deicing composition utilized. In some forms, the phase change material is present in an amount between 5% and 25, 20, or 15%.

In some instances, the phase change material may be selected from the group including paraffins, non-paraffin organics (ethylene glycol, formic acid), salt hydrates (sodium sulfate decahydrate, Dowtherm), metallics, fused salt eutectics, solid-solid, n-tetradecane, n-hexadecane, n-octadecane, n-pentadecane, n-Eicosane, polyethylene glycol 600, acetic acid, tristearin, myristic acid, stearic acid, elaidic acid, acetamide, methyl fumarate, oxazoline wax—TS-970, oxazoline wax—ES-254, sodium hydrogen phosphate dodecahydrate, lithium nitrate trihydrate, barium hydroxide octahydrate, and any combination thereof.

As used herein, “a”, “an”, and “the” refer to both singular and plural referents unless the context clearly dictates otherwise.

As used herein, the term “or”, including the claims, is used to mean “and/or” unless explicitly indicated to refer to alternatives only or to refer to the alternatives that are mutually exclusive.

As used herein, the term “about” refers to a measurable value such as a parameter, an amount, a temporal duration, and the like and is meant to include variations of +/−15% or less, preferably variations of +/−10% or less, more preferably variations of +/−5% or less, even more preferably variations of +/−1% or less, and still more preferably variations of +/−0.1% or less of and from the particularly recited value, in so far as such variations are appropriate to perform in the invention described herein. Furthermore, it is also to be understood that the value to which the modifier “about” refers is itself specifically disclosed herein.

As used herein, spatially relative terms, such as “beneath”, “below”, “lower”, “above”, “upper”, “front”, “back”, “side”, “left”, “right”, “rear”, and the like, are used for ease of description to describe one element or feature's relationship to another element(s) or feature(s). It is further understood that the terms “front”, “back”, “left”, and “right” are not intended to be limiting and are intended to be interchangeable, where appropriate. Further, it should be noted that the terms “first,” “second,” and the like herein do not denote any order, quantity, or relative importance, but rather are used to distinguish one element from another.

As used herein, the terms “comprise(s)”, “comprising”, and the like, specify the presence of stated features, integers, steps, operations, elements, and/or components, but do not preclude the presence or addition of one or more other features, integers, steps, operations, elements, components, and/or groups thereof.

As used herein, the terms “configure(s)”, “configuring”, and the like, refer to the capability of a component and/or assembly, but do not preclude the presence or addition of other capabilities, features, components, elements, operations, and any combinations thereof.

Chemical compounds are described using standard nomenclature. For example, any position not substituted by any indicated group is understood to have its valency filled by a bond as indicated, or a by hydrogen atom.

All ranges disclosed herein are inclusive of the endpoints, and the endpoints are independently combinable with each other. Each range disclosed herein constitutes a disclosure of any point or sub-range lying within the disclosed range.

All methods described herein can be performed in any suitable order unless otherwise indicated herein or otherwise clearly contradicted by context. The use of any and all examples, or exemplary language (e.g., “such as”), is intended merely to better illustrate the invention and does not pose a limitation on the scope of the invention or any embodiments unless otherwise claimed.

Any combination or permutation of features, functions and/or embodiments as disclosed herein is envisioned. Additional advantageous features, functions and applications of the disclosed systems, methods and assemblies of the present disclosure will be apparent from the description which follows, particularly when read in conjunction with the appended figures. All references listed in this disclosure are hereby incorporated by reference in their entireties.

This written description uses examples to disclose the disclosure, including the best mode, and also to enable any person skilled in the art to practice the disclosure, including making and using any devices or systems and performing any incorporated methods. The patentable scope of the disclosure is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

Definitions and methods described herein are provided to better define the present disclosure and to guide those of ordinary skill in the art in the practice of the present disclosure. Unless otherwise noted, terms are to be understood according to conventional usage by those of ordinary skill in the relevant art.

### BRIEF DESCRIPTION OF THE DRAWINGS

Features and aspects of embodiments are described below with reference to the accompanying drawings, in which elements are not necessarily depicted to scale.

Exemplary embodiments of the present disclosure are further described with reference to the appended figures. It is to be noted that the various features, steps and combinations of features/steps described below and illustrated in the figures can be arranged and organized differently to result in embodiments which are still within the scope of the present disclosure.

To assist those of ordinary skill in the art in making and using the disclosed assemblies, systems and methods, reference is made to the appended figures, wherein:

FIG. 1 illustrates Phase Change Materials (PCMs) in concrete via lightweight aggregates (LWAs), according to the present disclosure;

FIG. 2 illustrates MPCMs in concrete, according to the present disclosure;

FIG. 3 illustrates a cross-sectional view of a concrete slab fabricated from a concrete mixture with PCM-LWA, according to the present disclosure;

FIG. 4 illustrates the ramp rate effect, wherein heat flow is depicted along the y-axis and temperature is depicted along the x-axis, according to the present disclosure;

FIG. 5 illustrates a cross-sectional view of a concrete slab fabricated from a concrete mixture with MPCM, according to the present disclosure;

FIG. 6 illustrates a transition between a solid, a liquid, and a vapor of a PCM, according to the present disclosure;

FIG. 7 illustrates a packaged PCM-deicer, according to the present disclosure;

FIG. 8 illustrates a thermal profile of a PCM, wherein the y-axis depicts heat flow, and the x-axis depicts temperature, according to the present disclosure;

FIG. 9A illustrates pore characterization of an LWA, wherein the y-axis depicts moisture content, and the x-axis depicts relative humidity, according to the present disclosure;

FIG. 9B illustrates pore characterization of an LWA, wherein the y-axis depicts cumulative moisture content, and the x-axis depicts pore radius, according to the present disclosure;

FIG. 10A illustrates a PCM6P specimen including liquid paraffin oil, according to the present disclosure;

FIG. 10B illustrates a MPCM6D specimen including micro-encapsulated PCM (MPCM), according to the present disclosure;

FIG. 10C illustrates specimens of LWA 1+PCM6P, LWA2+PCM6P, and LWA3+PCM6P, according to the present disclosure;

FIG. 11 illustrates a DSC thermograms of tested specimens, wherein the y-axis depicts heat flow, and the x-axis depicts temperature, according to the present disclosure;

FIG. 12A illustrates a graph of ramp rate versus delta T, according to the present disclosure;

FIG. 12B illustrates a graph of ramp rate versus freezing temperature, according to the present disclosure;

FIG. 12C illustrates a graph of ramp rate versus freezing enthalpy of fusion, according to the present disclosure;

FIG. 12D illustrates a graph of ramp rate versus melting temperature, according to the present disclosure;

FIG. 13A illustrates a graph of thermal efficiency of a freezing event for various specimens, wherein the y-axis depicts heat flow, and the x-axis depicts temperature, according to the present disclosure;

FIG. 13B illustrates a graph of thermal efficiency of a melting event for various specimens, wherein the y-axis depicts heat flow, and the x-axis depicts temperature, according to the present disclosure;

FIG. 13C illustrates the freezing and melting efficiencies for the tested specimen, according to the present disclosure;

FIG. 14A illustrates the desorption behavior of LWA#1, wherein the y-axis depicts moisture content, and the x-axis depicts relative humidity, according to the present disclosure;

FIG. 14B illustrates the desorption behavior of LWA#2, wherein the y-axis depicts moisture content, and the x-axis depicts relative humidity, according to the present disclosure;

FIG. 14C illustrates the desorption behavior of LWA#3, wherein the y-axis depicts moisture content, and the x-axis depicts relative humidity, according to the present disclosure;

FIG. 15A illustrates the LWA pore size categories, according to the present disclosure;

FIG. 15B illustrates a graph of pore size radius versus melting temperature, according to the present disclosure;

FIG. 16A illustrates a graph of pore size range versus moisture content, according to the present disclosure;

FIG. 16B illustrates a graph of pore size radius versus moisture content, according to the present disclosure;

FIG. 16C illustrates specimen pore size, according to the present disclosure;

FIG. 17 illustrates a cross-sectional view of a concrete slab fabricated from a concrete mixture, according to the present disclosure;

FIG. 18A illustrates a concrete mixture being tested under the ASTM C143 slump test, according to the present disclosure;

FIG. 18B illustrates the results of the ASTM C143 and ASTM C231 tests, according to the present disclosure;

FIG. 18C illustrates a portion of the test setup for testing under the ASTM C231 air content test, according to the present disclosure;

FIG. 19A illustrates city temperature per hour comparisons across winter months, according to the present disclosure;

FIG. 19B illustrates a Longitudinal Guarded Comparative (LGCC) Test system, according to the present disclosure;

FIG. 19C illustrates a temperature per time per temperature graph indicating the phase transition region of PCM, according to the present disclosure;

FIG. 20A illustrates the thermal assessment of PCM-LWA in a cement mixture, wherein the left y-axis depicts heat flow, the right y-axis depicts temperature, and the x-axis depicts time, according to the present disclosure;

FIG. 20B illustrates the thermal assessment of MPCM in a cement mixture, wherein the left y-axis depicts heat flow, the right y-axis depicts temperature, and the x-axis depicts time, according to the present disclosure;

FIG. 20C illustrates the thermal assessment of PCM-LWA in a cement mixture, wherein the y-axis depicts heat flow through PCM-LWA mortar, and the x-axis depicts temperature, according to the present disclosure;

FIG. 20D illustrates the thermal assessment of MPCM in a cement mixture, wherein the y-axis depicts heat flow through MPCM mortar, and the x-axis depicts temperature, according to the present disclosure;

FIG. 21A illustrates large-scale slab deicing testing with a PCM-LWA concrete slab, a MPCM concrete slab, and a reference concrete slab, according to the present disclosure;

FIG. 21B illustrates a top view of a concrete slab, according to the present disclosure;

FIG. 21C illustrates a cross-sectional view of the concrete slab of FIG. 21B, according to the present disclosure;

FIG. 21D illustrates large-scale slab deicing testing with a PCM-LWA concrete slab, a MPCM concrete slab, and a reference concrete slab, according to the present disclosure;

FIG. 22A illustrates a cross-sectional view of the concrete slab of FIG. 21B, wherein the concrete slab is divided into five (5) layers, according to the present disclosure;

FIG. 22B illustrates a cross-sectional view similar to FIG. 22A, wherein the reference concrete slab is divided into five (5) layers , according to the present disclosure;

FIG. 22C illustrates a cross-sectional view similar to FIG. 22A, wherein the PCM-LWA concrete slab is divided into five (5) layers , according to the present disclosure;

FIG. 22D illustrates a cross-sectional view similar to FIG. 22A, wherein the MPCM concrete slab is divided into five (5) layers , according to the present disclosure;

FIG. 23A illustrates the air temperature in December 2021, according to the present disclosure;

FIG. 23B illustrates the air temperature in January 2022, according to the present disclosure;

FIG. 23C illustrates the air temperature in February 2022, according to the present disclosure;

FIG. 23D illustrates the air temperature in March 2022, according to the present disclosure;

FIG. 24A illustrates a thermal assessment of the tested concrete slabs during the month of December 2021, wherein the y-axis depicts number of freeze-thaw cycles, and the x-axis depicts each layer of the tested concrete slabs, as illustrated in FIG. 22A, according to the present disclosure;

FIG. 24B illustrates a thermal assessment of the tested concrete slabs during the month of January 2022, wherein the y-axis depicts number of freeze-thaw cycles, and the x-axis depicts each layer of the tested concrete slabs, as illustrated in FIG. 22A, according to the present disclosure;

FIG. 24C illustrates a thermal assessment of the tested concrete slabs during the month of February 2022, wherein the y-axis depicts number of freeze-thaw cycles, and the x-axis depicts each layer of the tested concrete slabs, as illustrated in FIG. 22A, according to the present disclosure;

FIG. 24D illustrates a thermal assessment of the tested concrete slabs during the month of March 2022, wherein the y-axis depicts number of freeze-thaw cycles, and the x-axis depicts each layer of the tested concrete slabs, as illustrated in FIG. 22A, according to the present disclosure;

FIG. 25 illustrates a thermal assessment of the tested concrete slabs as it relates to the freeze-thaw cycles illustrated in FIGS. 24A-24D, according to the present disclosure;

FIG. 26 illustrates the snow-melting performance of the tested concrete slabs, wherein the y-axis depicts temperature, and the x-axis depicts time, according to the present disclosure;

FIG. 27A illustrates the split tensile strength testing of the three concrete mixtures, according to the present disclosure;

FIG. 27B illustrates the compressive strength testing of the three concrete mixtures, according to the present disclosure;

FIG. 28A illustrates the testing of a concrete specimen for water absorption/sorptivity, according to the present disclosure;

FIG. 28B illustrates the testing of a concrete specimen for water absorption/sorptivity, according to the present disclosure;

FIG. 28C illustrates the testing of a concrete specimen for water absorption/sorptivity, according to the present disclosure;

FIG. 29A illustrates the water absorption/sorptivity results from the testing depicted in FIGS. 28A-28C, according to the present disclosure; and

FIG. 29B illustrates the water absorption/sorptivity results from the testing depicted in FIGS. 28A-28C, wherein the y-axis depicts absorption, and the x-axis depicts time, according to the present disclosure.

### DETAILED DESCRIPTION OF THE DISCLOSURE

The present disclosure is directed to compositions and methods for deicing and protecting surfaces from water, snow, and ice damage. Phase change materials (PCM) may provide an effective buffer to accommodate temperature changes and cycling as they store energy when they melt but release that stored latent heat when they freeze.

In some embodiments, PCMs may be used in conjunction with mixtures of deicers to provide enhanced melting performance for a wide range of temperatures. In other embodiments, PCMs may be used as separate additives synergistically with the deicers. In yet another embodiment, PCMs may be impregnated into porous materials such as lightweight aggregate (LWA), sand, gravel, and related materials. As described in more detail below, the porous materials may be used to make a concrete mixture. In yet another embodiment, PCMs may be coated on hard materials (e.g., sodium chloride crystals).

In one exemplary embodiment, phase change materials (PCM) may be incorporated into a mixture (e.g., concrete mixture). The incorporation of PCMs into concrete, for example, may provide a viable alternative to conventional snow-melt solutions (e.g., deicing salts). However, deicing salts and combinations thereof (e.g., deicing salt with PCM) may be used in conjunction with concrete mixtures including PCM. PCMs undergo phase change at temperatures at or above 0° C. (32° F.) and during the phase change, the PCMs store and release heat energy.

Incorporation of PCMs into a concrete mixture may occur through various methods. As used herein, and unless otherwise stated, examples discussing PCMs within a concrete mixture may refer to any of the non-limiting processes, including, (1) inclusion of liquid PCM in concrete mix (bulk incorporation), (2) lightweight aggregates (LWAs) immersed in PCM to form ‘PCM-LWA’ which may be then used to mix concrete as a partial replacement of fine aggregates, (3) filling tubes inside concrete with PCM, (4) microencapsulated PCMs directly mixed with concrete, and combinations thereof.

In some examples, when PCM is applied to porous surfaces, such as concrete, some of the PCM will leach out of the lightweight aggregate. The leached PCM will protect these surfaces from water damage via a thin coating that repels water. Water damage occurs as water seeps into concrete and freezes. Water expands as it freezes, which can damage concrete's structural integrity. By releasing PCM onto the concrete surface, it protects it from damaging freeze-thaw cycles.

The pores of an LWA may be sized and shaped differently. In some instances, the size of the pores may range between about a few nanometers and about a few millimeters. In some embodiments, the pores may range between about 4.2 nanometers to an amount greater than about 17.3 nanometers. In some instances, the pores of an LWA may be spherical, cylindrical, and combinations thereof. It should be understood that one LWA may include variations and combinations of the above parameters.

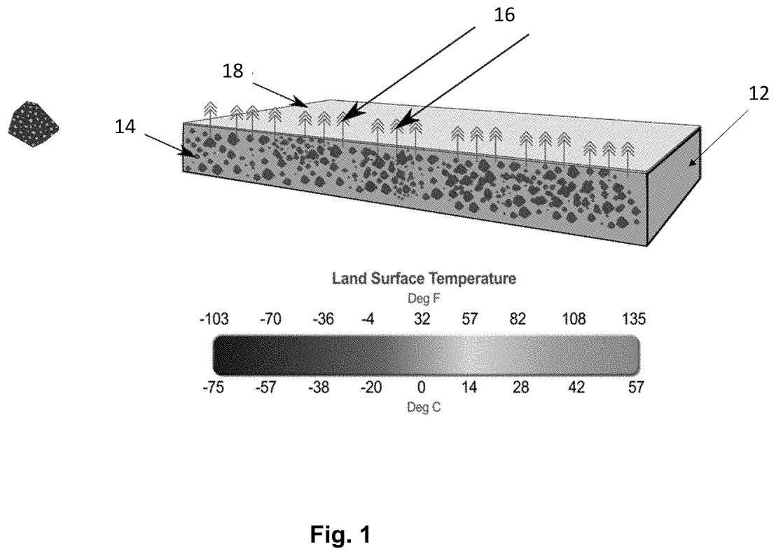

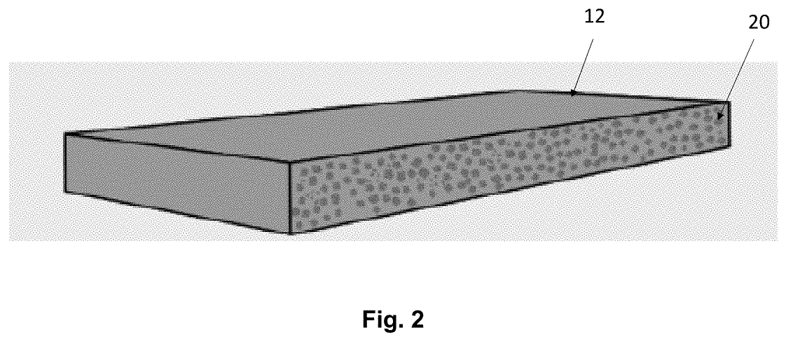

In one example, FIG. 1 illustrates LWAs immersed in PCM to form ‘PCM-LWA’ 14 which was used to form the concrete slab 12. The concrete slab 12 may also include combinations of cement mix, water, and fine aggregates. The PCM-LWA composition 14 may be at least a partial replacement for fine aggregates. In another example, FIG. 2 illustrates MPCM 20 incorporated into a concrete slab 12.

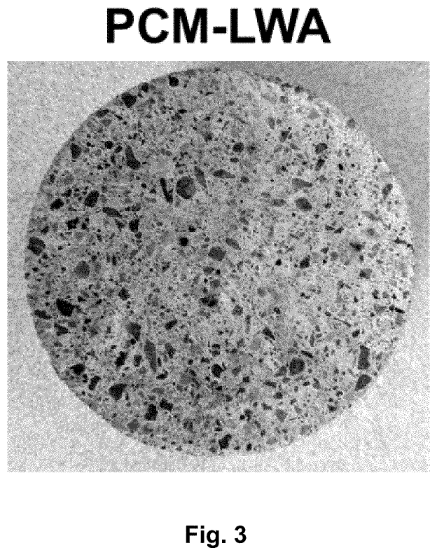

In a non-limiting example, about 110 kg/m3 of PCM may be added to a concrete mixture. In a non-limiting example and as illustrated in a cross-sectional view of a concrete slab (FIG. 3), a concrete mixture may include about 47.5% of cement paste (e.g., cement mix, water), between about 44.5% and about 47.5% of PCM-LWA and between about 5% and about 8% air content. While the freezing temperature of pure water=0° C., PCMs undergo phase change at temperatures above 0° C. and are suitable for snow melting applications. As heat energy 16 is released from the PCMs, snow/ice 18 may be melted.

In some instances, variable temperature change rates may also affect thermal behavior of the PCM inside an LWA. For example, one critical factor that may affect the thermal behavior of the PCM is the temperature change rate. The temperature change rate dictates the rate at which heat is removed/added from/to the system. Temperature change rate also influences the movement of the molecules from the liquid phase to the solid phase and the creation of nucleation sites. In addition, temperature change rate also influences the degree of undercooling, which is a phenomenon where the PCM remains a liquid below the freezing temperature. Another critical factor that can affect the thermal behavior of PCM is pore confinement, which is also known as the Gibbs-Thomson effect. Liquids in pores of nanometer scale experience freezing point depression, especially for pores smaller than 20 nm.

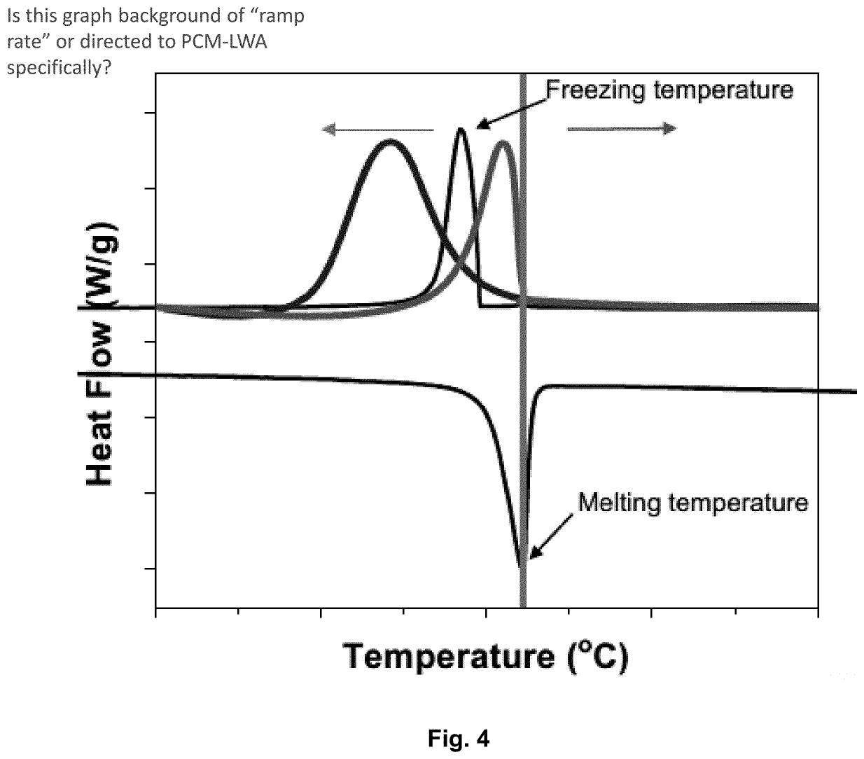

Ramp rate effect of PCM is shown in FIG. 4. For a cooling rate≈0° C. s−1, the melting temperature is approximately equal to the freezing temperature. ΔT=(melting temperature−freezing temperature) and therefore ΔT≈0. There is heat release at a sharp peak and minimal undercooling for a cooling rate≈0° C. s−1. For cooling rate>>0° C. s−1, melting temperature≠freezing temperature. ΔT=(melting temperature−freezing temperature) and therefore ΔT>>0. There is heat released over a large range of temperature and a high degree of undercooling for cooling rate*>>0° C. s−1. Thus, as the cooling rate slows, the PCM produces heat flow at a faster rate than when the cooling rate speeds up, which produces a slower heating rate of the PCM.

With respect to pore confinement, the Gibbs-Thomson equation (below) can be modified to correlate the effect of pore size and melting temperature. The Gibbs-Thomson equation may be modified to recite “2*T_{m-bulk}” as noted below. Depending on the pore size, capillary pressure on the PCM liquid will differ, and depending on the magnitude of the pressure, the freezing/melting temperature of PCM inside the pores of LWA will be depressed.

$$Gibbs - Thomson {Equation}^{⋆} : {T}_{m - pores} = {T}_{m - bulk} - {2}^{⋆} {T}_{m - bulk} ⋆ \frac{{γ}_{L / S} ⋆ {V}_{L}}{Δ {H}_{L / S} ⋆ r}$$

(See Esmaeeli, H. S., Farnam, Y., Haddock, J. E., Zavattieri, P. D., & Weiss, W. J. (2018). Numerical analysis of the freeze-thaw performance of cementitious composites that contain phase change material (PCM). Materials & Design, 145, 74-87).

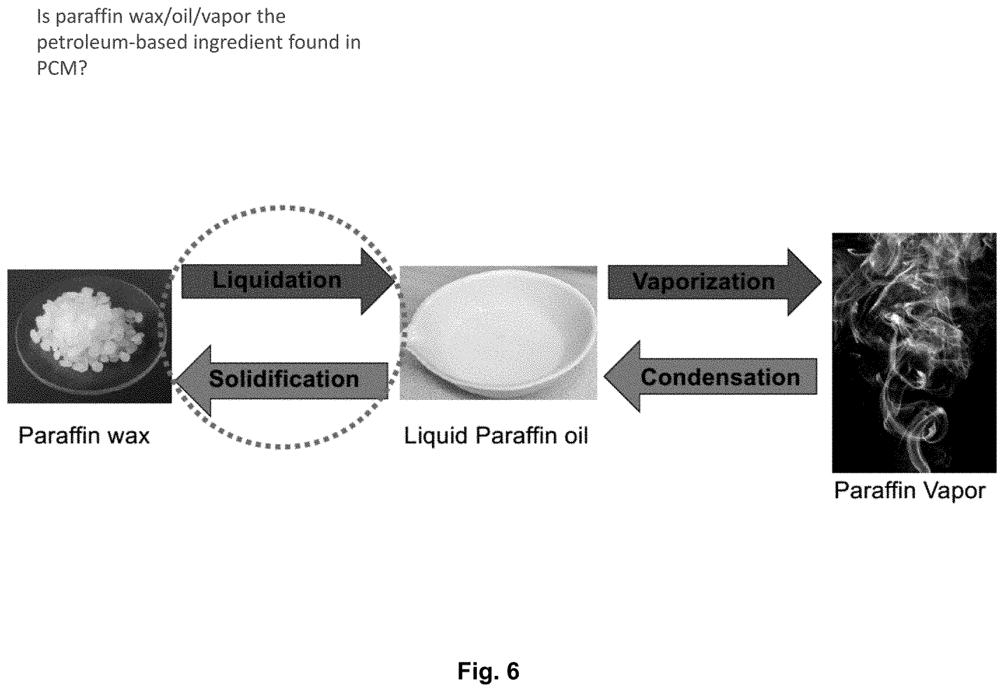

FIG. 6 depicts an exemplary embodiment of a PCM (e.g., paraffin) transitioning between phases. As disclosed herein, PCMs include materials capable of storing or releasing heat energy during phase transition. Solidification and condensation phase transitions are exothermic processes, while liquefaction and vaporization are endothermic processes.

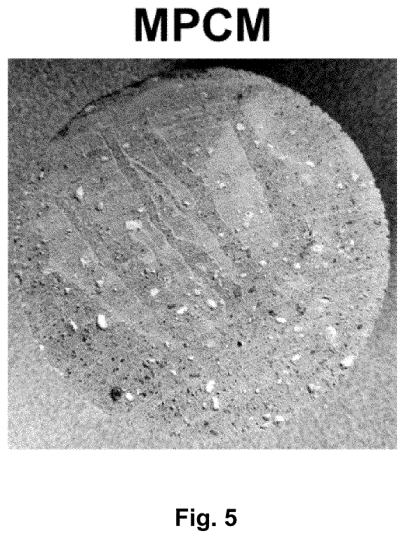

In a non-limiting example and as illustrated in a cross-sectional view of a concrete slab (FIG. 5), a concrete mixture may include about 47.5% of cement paste (e.g., cement mix, water), between about 27.46% and about 30.5% of aggregates (e.g., gravel, sand), between about 17.1% and about 17.48% of micro-encapsulated PCM (MPCM), and between about 5% and about 8% of air content. A concrete slab including MPCM may function similarly to the PCM-LWA composition described above.

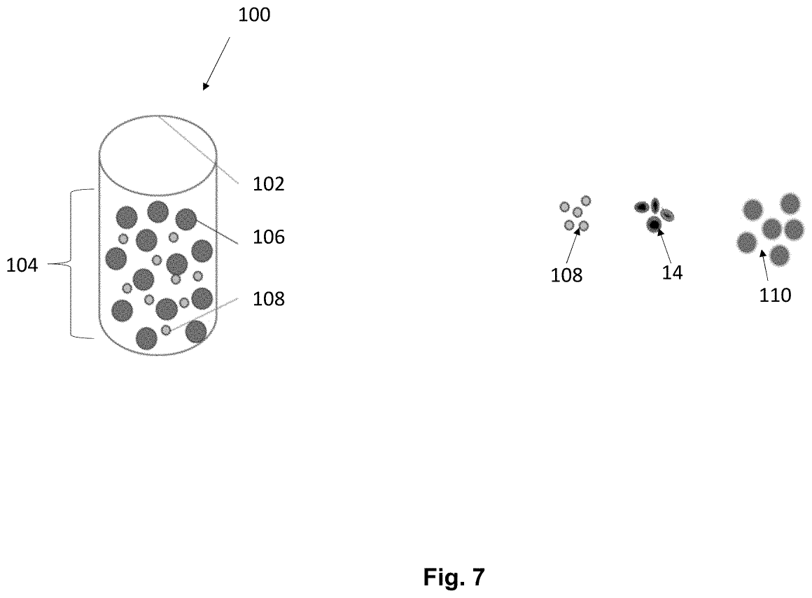

In another exemplary embodiment, PCMs may be used in conjunction with deicing salts. For example, the PCMs described herein may be packaged with deicing salts (“deicer”) in the form of granulated additive, PCM impregnated light-weight aggregates or coated onto salt or other deicer crystals (FIG. 7).

As depicted in FIG. 7, packaged PCM-deicer 100 may include package 102, which defines an internal volume, and PCM-deicer composition 104. Package 102 may include, but is not limited to, bags, totes, railcars, supersacks and other packaging sizes. The PCM-deicer composition 104 may contain a synergistic amount of incorporated PCMs (e.g., about 1% to about 99% or as described above) 108 with deicer 106. The deicing salts 106 may include, but are not limited to, sodium chloride, calcium chloride, urea, magnesium chloride, potassium sulfate, lignin sulfonate, sodium sulfate, sodium silicates, NaCl, KCl, MgCl2, calcium magnesium acetate, and combinations thereof. The synergistic amount of incorporated PCMs 108 may include packaging separately with deicer 106, coating deicer 106 with PCM 108 to create a coated PCM with deicer 110, and combinations thereof. In some instances, PCM-deicer composition 104 may include PCM impregnated light-weight aggregates 14.

In operation, a user may unpack packaged PCM-deicer 100 and apply PCM-deicer composition 104 on an outdoor surface (e.g., concrete, asphalt, brick). Applying the combination of PCM-deicer composition 104 to outdoor surfaces may produce a synergistic combination and promote the melting of snow/ice.

Application of PCM-deicer composition 104 to outdoor surfaces, some of the PCM 108 will leach and protect the surfaces from water damage via a thin coating that repels water. Water damage occurs as water seeps into concrete and freezes. Water expands as it freezes, which can damage concrete's structural integrity. By releasing PCM 108 onto the outdoor surface, it protects it from damaging freeze-thaw cycles.

As noted above, deicing salts may experience freeze-thaw cycles that are detrimental to concrete. The incorporation of PCMs may exacerbate the freeze-thaw cycles and provide improved melting performance. For example, the deicing compositions will have improved melting performance in addition to the traditional deicer melting effectiveness, PCMs will melt snow/ice at other temperatures due to release of latent heat as the temperature drops. PCMs when impregnated on LWA of different particle sizes show a latent heat dissipation at a wide range of temperatures below the effective temperature range for traditional deicers.

Due to this, in some instances, lower quantities of deicing materials may be used in combination with PCMs. In other instances, PCMs may obviate the need for deicing salts.

In some examples, the LWA may resemble gravel and may be impregnated with petroleum-based PCMs to achieve substantially the same effect as deicing salts. In non-limiting results, the addition of the petroleum-based PCMs may help to decrease chloride waste from traditional deicing salts, improve freeze-thaw cycling performance as PCMs will leach out of the aggregate over time, thereby leaving a water repelling film on the surface, and may be used on concrete that is less than one year old.

As used herein, PCM may refer to paraffins, non-paraffin organics (e.g., ethylene glycol, formic acid), salt hydrates (e.g., sodium sulfate decahydrate, Dowtherm), metallics, fused salt eutectics, solid-solid, n-tetradecane, n-hexadecane, n-octadecane, n-pentadecane, n-Eicosane, polyethylene glycol 600, acetic acid, tristearin, myristic acid, stearic acid, elaidic acid, acetamide, methyl fumarate, oxazoline wax—TS-970, oxazoline wax—ES-254, sodium hydrogen phosphate dodecahydrate, lithium nitrate trihydrate, barium hydroxide octahydrate, and any combination thereof.

In some embodiments, PCM may be combined with a salt melt trigger. The salt melt trigger may include inorganic salts (e.g., a carbonate or an additional chloride such as potassium carbonate, lithium chloride, or magnesium chloride hexahydrate); an organic compound containing an ether group or a hydroxyl group; compounds with groups selected from the group consisting of saccharides, alcohols, glycols and glucosides, and any mixture or combination of the foregoing.

In some embodiments, PCM may be combined with a desiccant, which may absorb moisture from the composition. The desiccant may refer to SiO2 (also an anti-caking agent). When a desiccant is present, it is preferably used at levels of from about 0.05% by weight to about 0.3% by weight, and preferably from about 0.1% by weight to about 0.2% by weight, based upon the total weight of the deicing composition taken as 100% by weight.

In some embodiments, PCM may be combined with anti-caking agents. The anti-caking agents may include sodium aluminosilicate, sodium ferrocyanide, potassium ferrocyanide, calcium carbonate, magnesium carbonate, silicon dioxide (SiO2), stearates of calcium and magnesium, silica, talc, flour, starch, tricalcium phosphate, powdered cellulose, sodium bicarbonate, calcium ferrocyanide, calcium phosphate, sodium silicate, calcium silicate, magnesium trisilicate, potassium aluminum silicate, calcium aluminosilicate, bentonite, aluminum silicate, stearic acid, polydimethylsiloxane, and any combination thereof.

### EXAMPLE 1

Objectives. At least three objectives are addressed in the present disclosure.

Objective 1 includes investigating the thermal behavior of PCM for varying ramp rates.

Objective 2 includes characterizing the pore structure of LWAs selected for the investigation.

Objective 3 includes correlating the effect of ramp rates and pore size distribution of LWA on thermal behavior of PCM.

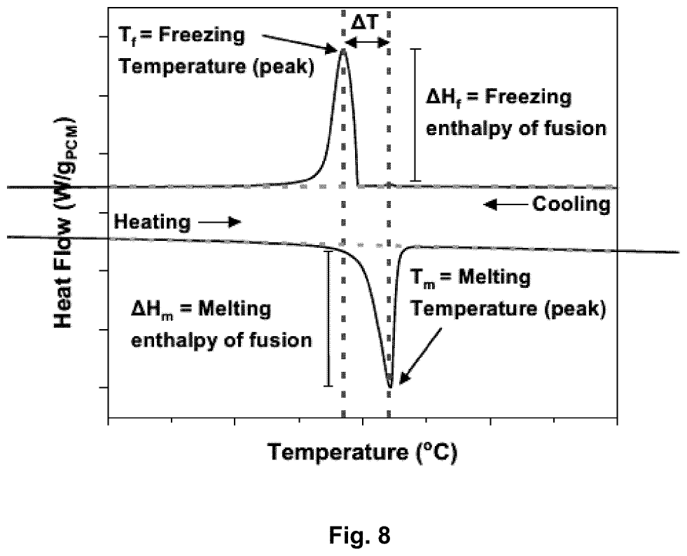

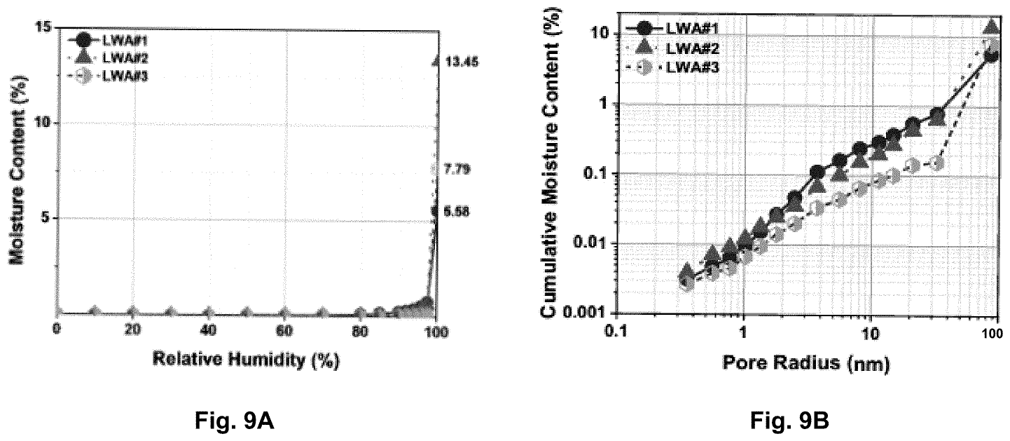

Experiments. Thermal profile experiments included Low-Temperature Differential Scanning calorimeter for generating temperature versus heat flow data for PCMs (FIG. 8). Pore structure characterization was carried out with a Dynamic Vapor Sorption (DVS) Analyzer. The Kelvin-Young Laplace equation (below) was used to determine relative humidity versus moisture content (FIG. 9A) and pore radius versus cumulative moisture content (FIG. 9B) for each of the LWA#1, LWA#2, and LWA#3 sample specimens.

$$Kelvin - Young Laplace {equation}^{⋆} : r = \frac{2 γ}{ln ( RH )} \times \frac{{V}_{m}}{R \times T}$$

(See Althoey, F., & Farnam, Y. (2020). Performance of Calcium Aluminate Cementitious Materials in the Presence of Sodium Chloride. Journal of Materials in Civil Engineering, 32(10), 04020277.)

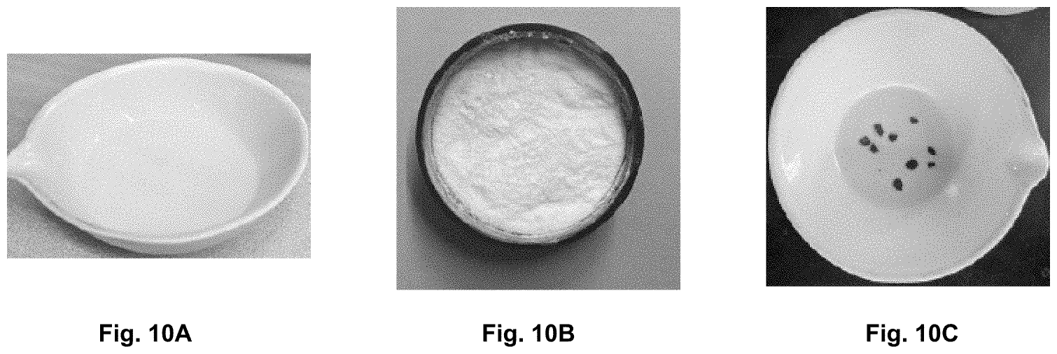

Materials. Types of PCM specimens included PCM6P and MPCM6D. PCM6P (bulk PCM) includes liquid paraffin oil having a T_{f/m}=3-6° C. (FIG. 10A). MPCM6D includes *MPCM micro-encapsulated PCM (FIG. 10B). Sample specimens included LWA1+PCM6P, LWA2+PCM6P, and LWA3+PCM6P (FIG. 10C).

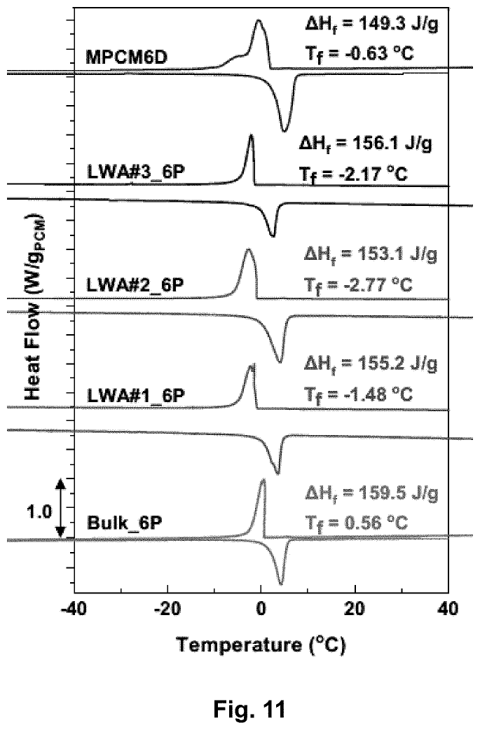

Results and Discussion. DSC thermograms of all specimens are shown in FIG. 11. Initial ramp rate for DSC test was 1° C./min. ΔH_{f}≈150-160 J/gPCM for all specimens. T_{f} is depressed for all specimens (significant undercooling) (T_{f/m}=3-6° C.). Two possible reasons for depression phenomenon may include ramp rate effect and/or confinement of PCM liquid in LWA and microcapsules.

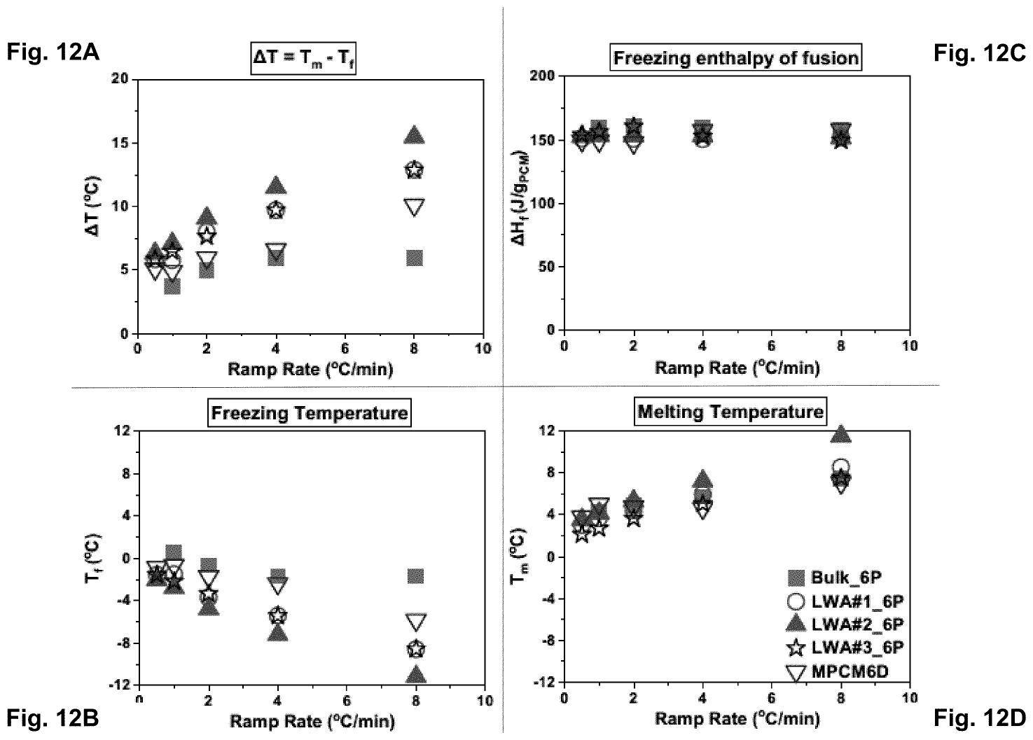

Ramp rates were varied as shown in FIGS. 12A-D. The ramp rates selected for this investigation were 0.5° C./min, 1° C./min, 2° C./min, 4° C./min, and 8° C./min. ΔT increased with the increase of ramp rate (FIG. 12A). ΔH_{f}≈150-160 J/gPCM for all ramp rates (FIG. 12C). Ramp rate versus freezing temperature is shown in FIG. 12B. Ramp rate versus melting temperature is shown in FIG. 12D. Ramp rates and pore confinement affected the following: rate of nucleation, number of nucleation sites, and crystallization growth rate.

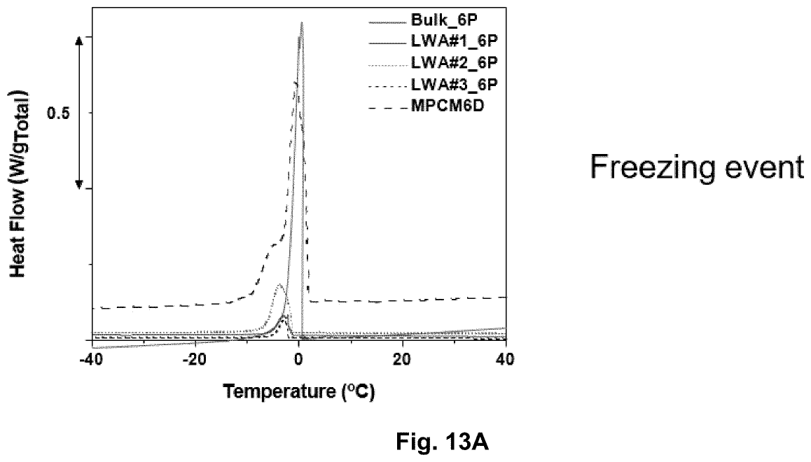

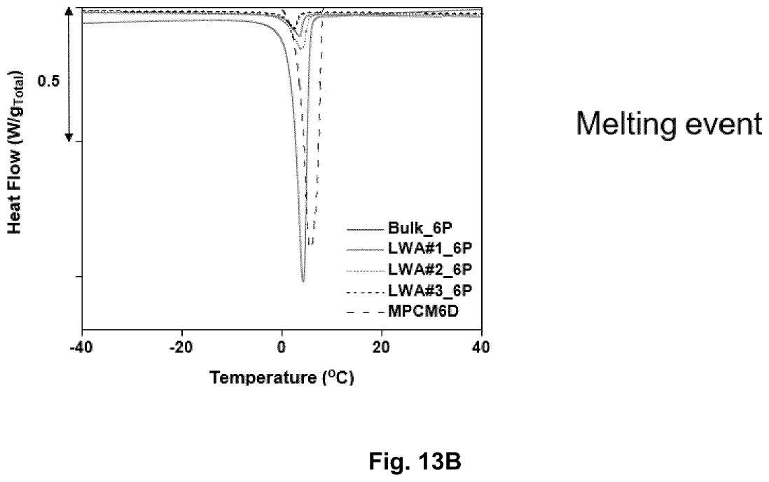

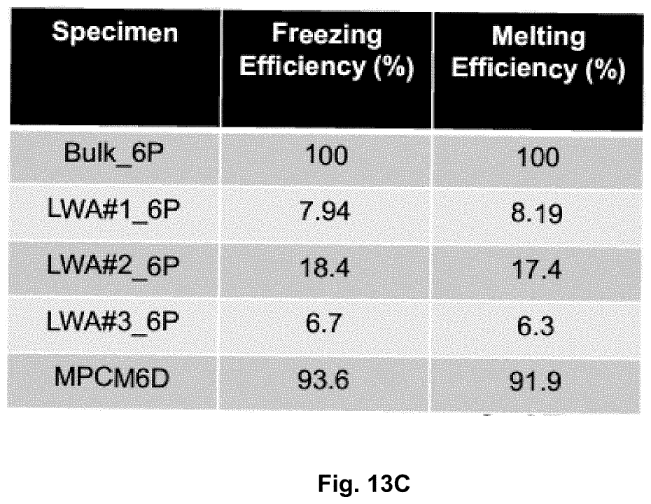

Thermal efficiency was evaluated as shown in FIGS. 13A-D. Freezing event and melting event thermal efficiency is shown in FIG. 13A and 13B, respectively. The freezing/melting efficiency percentage was calculated using the below equation.

$$‘ Freezing / Melting ’ efficiency ( \% ) = \frac{Δ {H}_{‘ f / m ’} ( J / {g}_{total} )}{Δ {H}_{‘ f / m ’} ( J / {g}_{total - Bulk} )} \times 100 \%$$

Specimen freezing and melting efficiencies are listed in the table of FIG. 13C. The efficiency of the LWA-PCM depended, in part, on the absorption capacity of the aggregate.

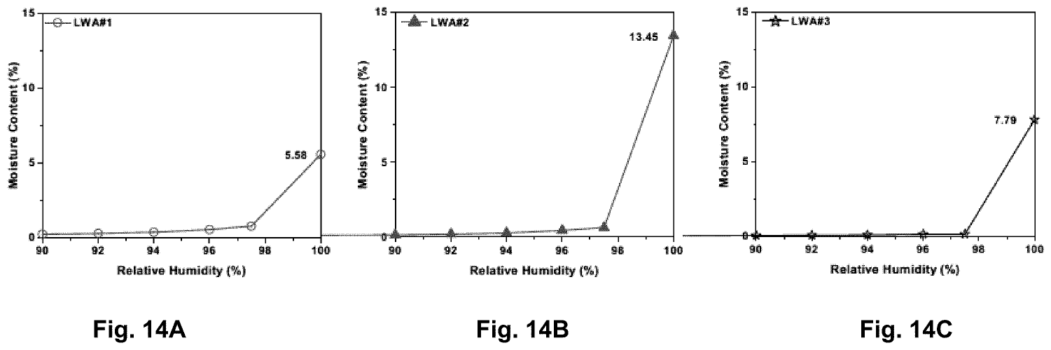

Desorption behaviors of LWA#1, LWA#2, and LWA#3 are depicted in FIGS. 14A, 14B, and 14C, respectively. LWA#2 was found to have the highest absorption capacity. All LWAs tested exhibited desorption behavior between about 90 and about 100%. This is an indication that a significant portion of volume fraction of LWAs consist of large and/or macro pores.

Selection of pore size ranges included the Gibbs-Thomson Analysis (below).

$$Gibbs - Thomson Analysis {T}_{m - pores} = {T}_{m - bulk} - {2}^{⋆} {T}_{m - bulk} ⋆ \frac{{γ}_{L / S} ⋆ {V}_{L}}{Δ {H}_{L / S} ⋆ r}$$

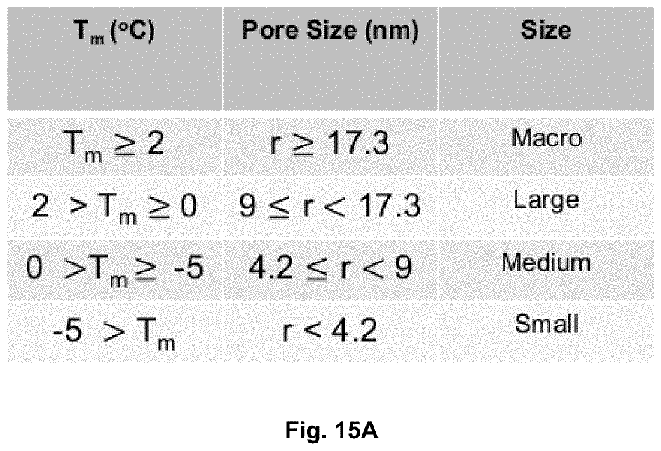

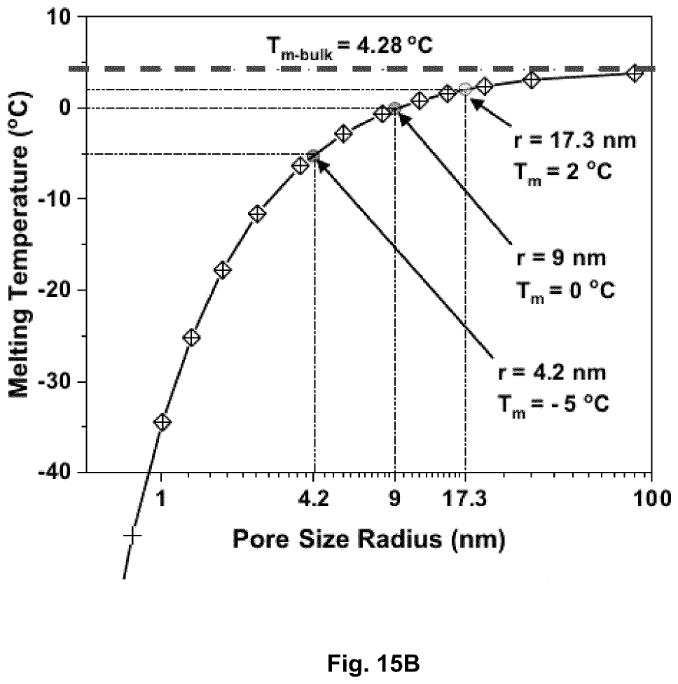

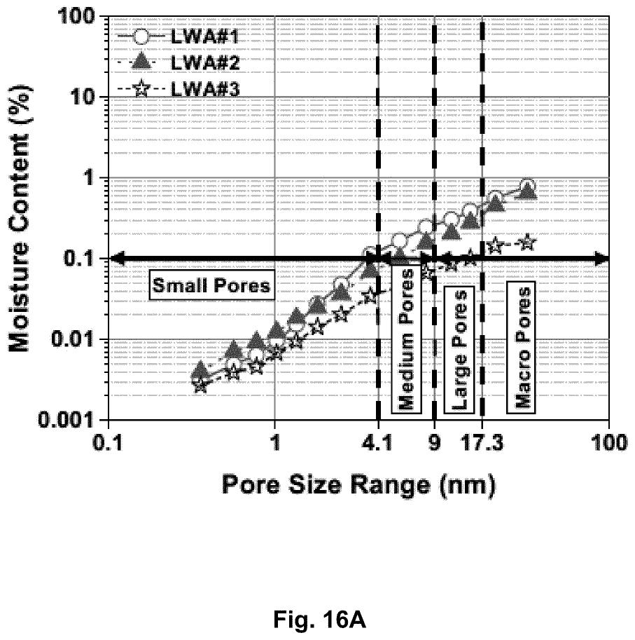

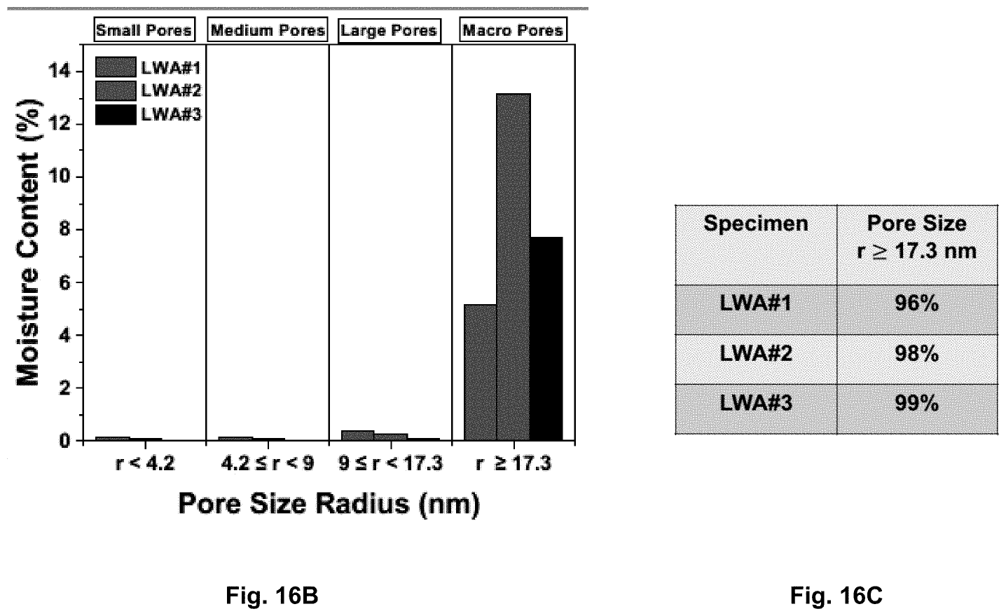

To categorize the pore sizes of LWA, four temperature ranges were selected (FIG. 15A). Pore size radius versus melting temperature is illustrated in FIG. 15B, pore size range versus moisture content is shown in FIG. 16A, and pore size radius versus moisture content is shown in FIG. 16B. Specimen pore sizes are listed in the table of FIG. 16C. All three LWAs have at least about 96% of the total pores larger than about 17.3 nm. LWA#2 had the largest volume fraction of macro pores. According to Gibbs-Thomson Analysis, PCM liquid present in pores larger than about 17.3 nm will undergo phase change between about 2° C. and about 4° C.

Summary and Conclusions. In summary, thermal behavior of PCMs at different ramp rates demonstrated that enthalpy of fusion for PCM specimens remain consistent, degree of undercooling is related to the ramp rate, and thermal efficiency of ‘LWA-PCM’ depends on the absorption capacity of LWA. Pore size characterization of LWAs showed that for all LWAs, at least 96% of the pore volume fraction are macropores (r>17.3 nm). Gibbs-Thomson Analysis revealed that PCM liquid in macropores should undergo phase transition between 2 to 4° C.

In conclusion, efficiency of ‘LWA-PCM’ incorporation depends, in part, on two factors: (1) ramp rate and (2) pore size of the LWA. In exemplary embodiments, LWA#2 may be the desired aggregate suited for the ‘PCM-LWA’ incorporation in concrete for deicing applications. Accordingly, based on the region, LWA should be selected based on absorption capacity and pore size distribution. Further, as described herein, MPCMs are effective for deicing applications. Depending upon the embodiment, incorporation of MPCM may lower one or more mechanical properties of concrete.

### EXAMPLE 2

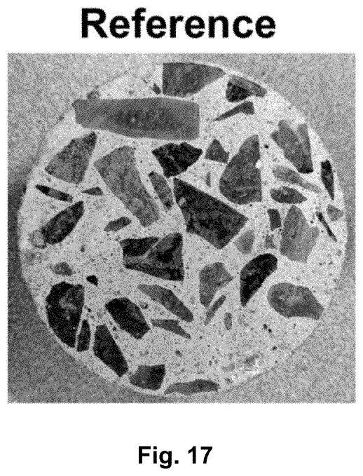

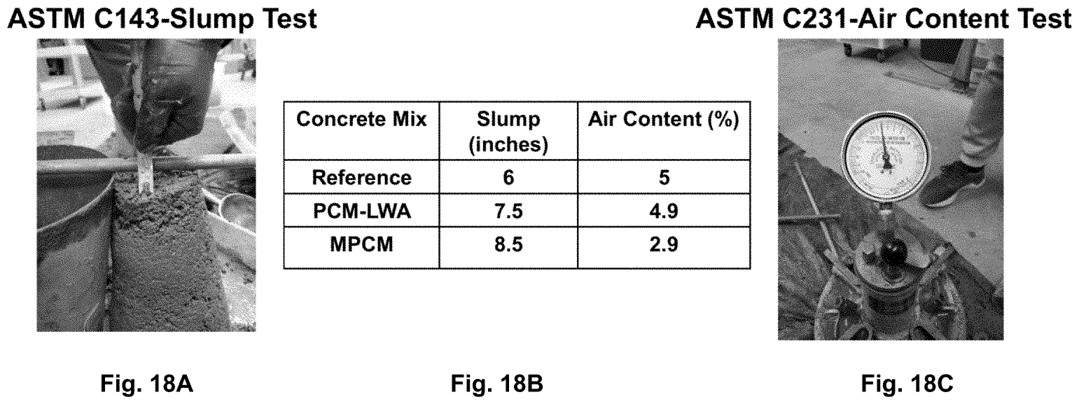

An exemplary optimization of concrete mix designs is further described below and in reference to FIGS. 18A-18C. The following tests were conducted using three concrete mixes, namely a reference of traditional concrete, a PCM-LWA concrete mixture, and a concrete MPCM mixture. The traditional concrete (reference) included between about 33.2% and about 34.5% cement paste, between about 59% and about 60.4% aggregates, and between about 5% and about 8% air content (FIG. 17). As noted above, the PCM-LWA concrete mixture included about 47.5% of cement paste (e.g., cement mix, water), between about 44.5% and about 47.5% of PCM-LWA and between about 5% and about 8% air content(FIG. 3). As also noted above, the MPCM concrete mixture included about 47.5% of cement paste (e.g., cement mix, water), between about 27.46% and about 30.5% of aggregates (e.g., gravel, sand), between about 17.1% and about 17.48% of MPCM, and between about 5% and about 8% of air content (FIG. 5).

The results of the ASTM C143—Slump Test are found in FIG. 18B, and a portion of the test is illustrated in FIG. 18A. Similarly, the results of the ASTM C231—Air Content Test are found in FIG. 18B, and a portion of the test is illustrated in FIG. 18C. As illustrated, the reference concrete mixture produced a slump of about 6 inches and an air content of about 5%, the PCM-LWA concrete mixture produced a slump of about 7.5 inches and an air content of about 4.9%, and the MPCM concrete mixture produced a slump of about 8.5 inches and an air content of about 2.9%.

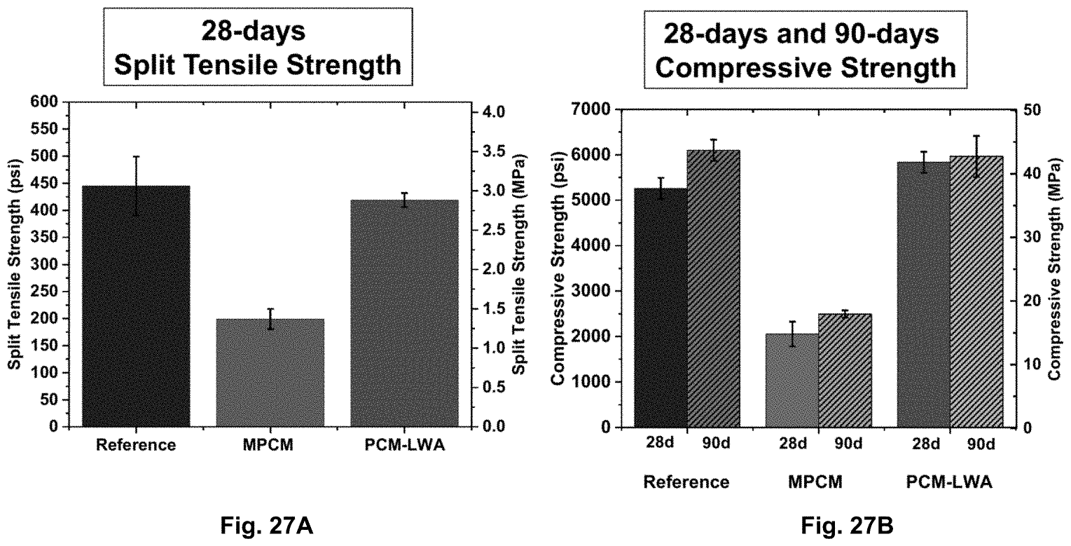

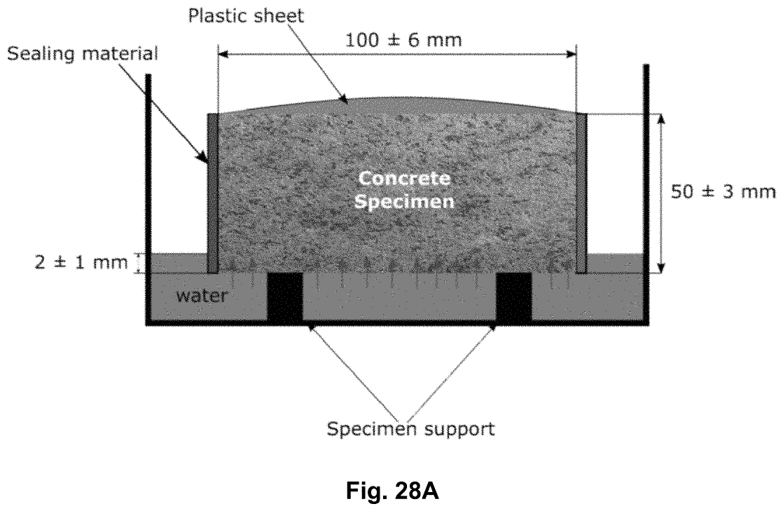

As a result, the tested mixtures produced acceptable slump and air content results. The tested mixtures also produced acceptable results for the mechanical strength tests, see FIG. 27A (split tensile strength) and FIG. 27B (compressive strength).

### EXAMPLE 3

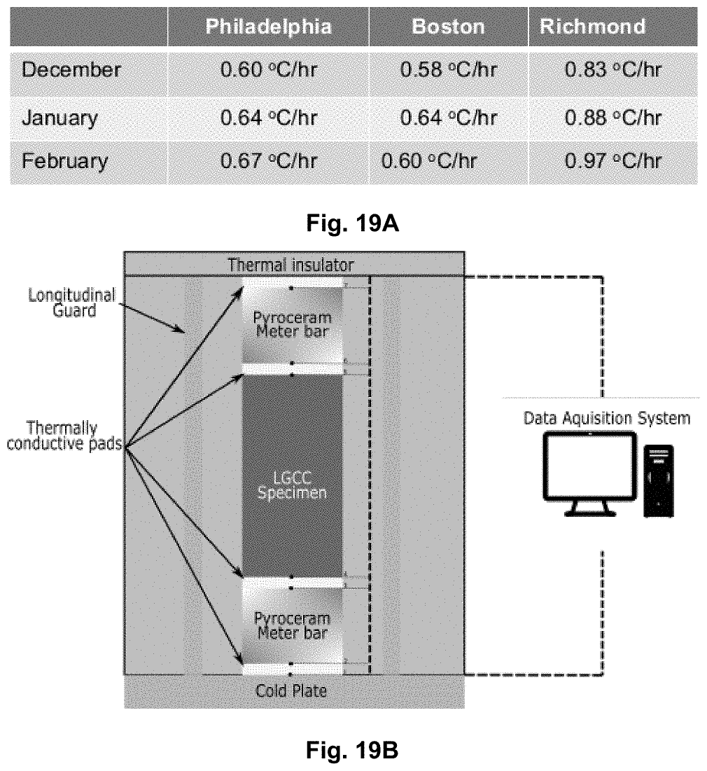

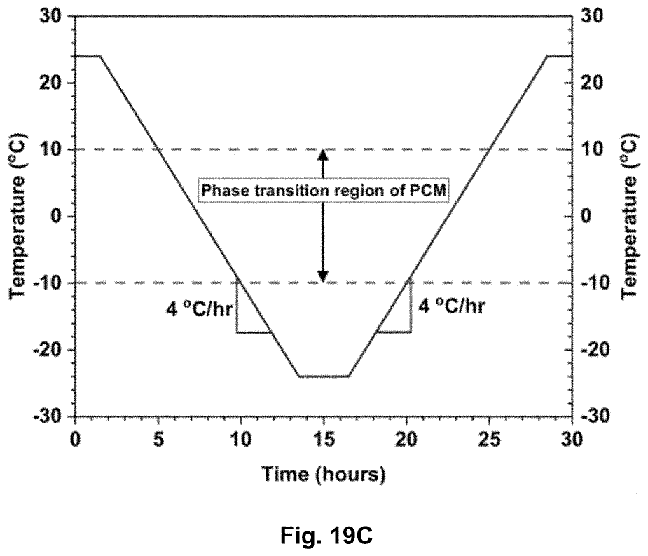

An exemplary experiment of the thermal assessment of PCM mortar specimens is discussed below and in reference to FIGS. 19A-26. The test illustrates a steady state method to obtain a measure of thermal conductivity of mortar specimens. The test utilizes Fourier's Law, which is reproduced below:

$$Fourier ' s law : q = - λ \frac{Δ T}{Δ z}$$

$${λ}_{s} = {λ}_{r} \frac{Δ {T}_{r}}{Δ {T}_{s}} \times \frac{Δ {Z}_{s}}{Δ {Z}_{r}}$$

Described in FIGS. 19A-19C is the basis of a LGCC (Longitudinal Guarded Comparative calorimetry) test intended to simulate one-dimensional heat flow through PCM concrete specimens (i.e., PCM-LWA, MPCM). FIG. 19A illustrates the city temperature per hour comparisons across winter months for three major cities near the East Coast. FIG. 19B illustrates a Longitudinal Guarded Comparative (LGCC) Test system. FIG. 19C illustrates a graph highlighting the phase transition region of PCM as compared with temperature and time.

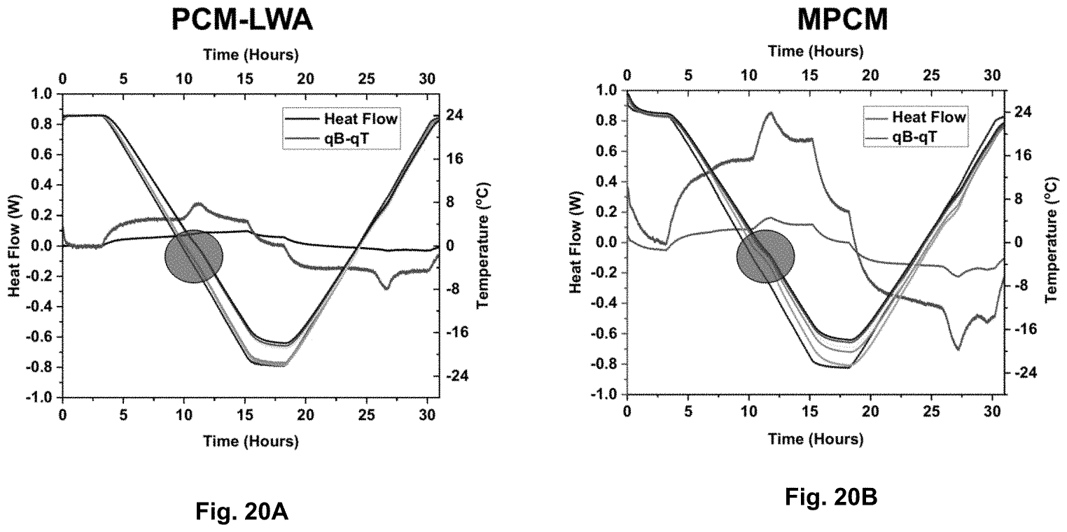

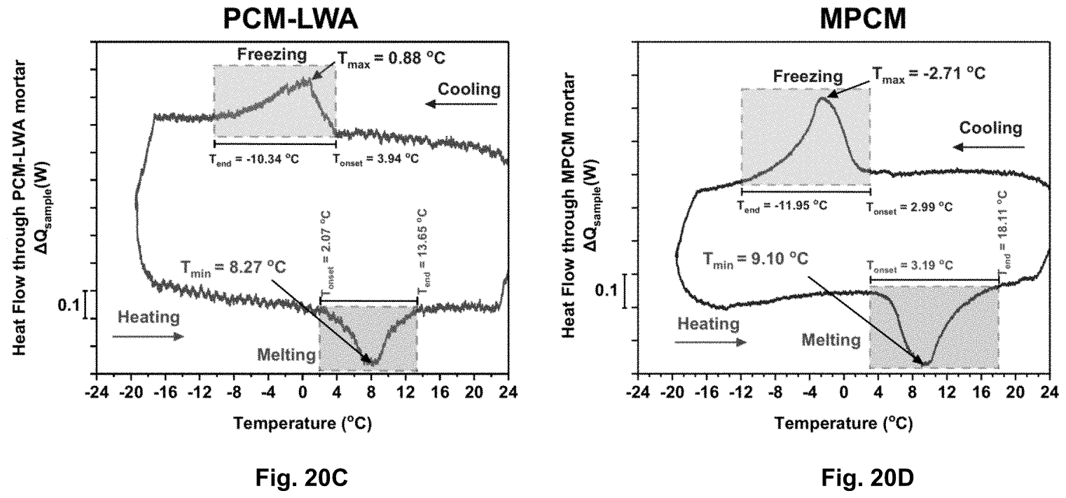

FIGS. 20A-20D illustrate the thermal assessment of PCM-LWA FIGS. 20A and 20C) and MPCM specimens (FIGS. 20B and 20D). The heat released at the first peak of the PCM-LWA specimen (FIG. 20C) is about 559.80 Joules. The heat released at the first peak of the MPCM specimen (FIG. 20D) is about 822.01 Joules.

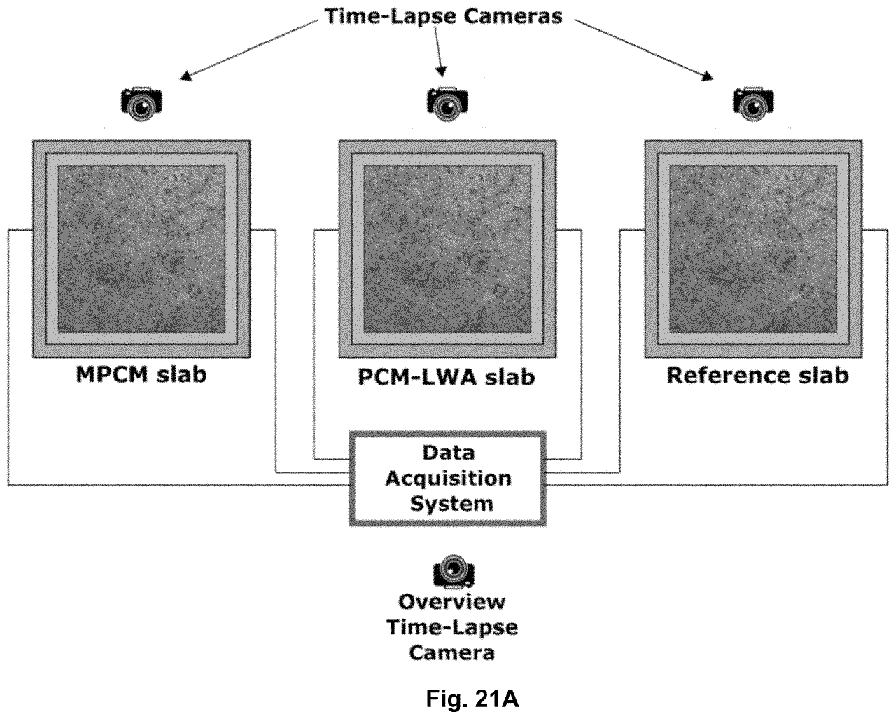

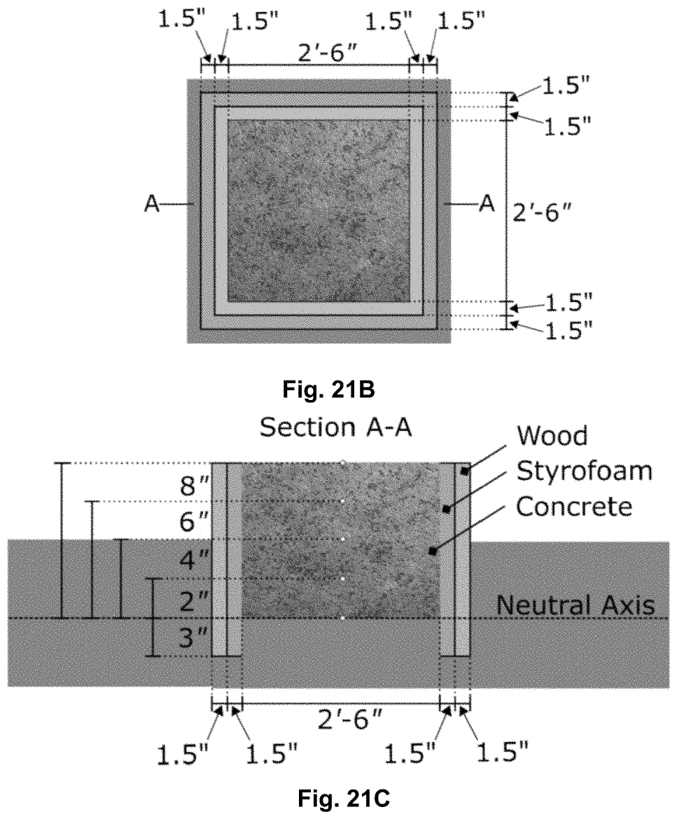

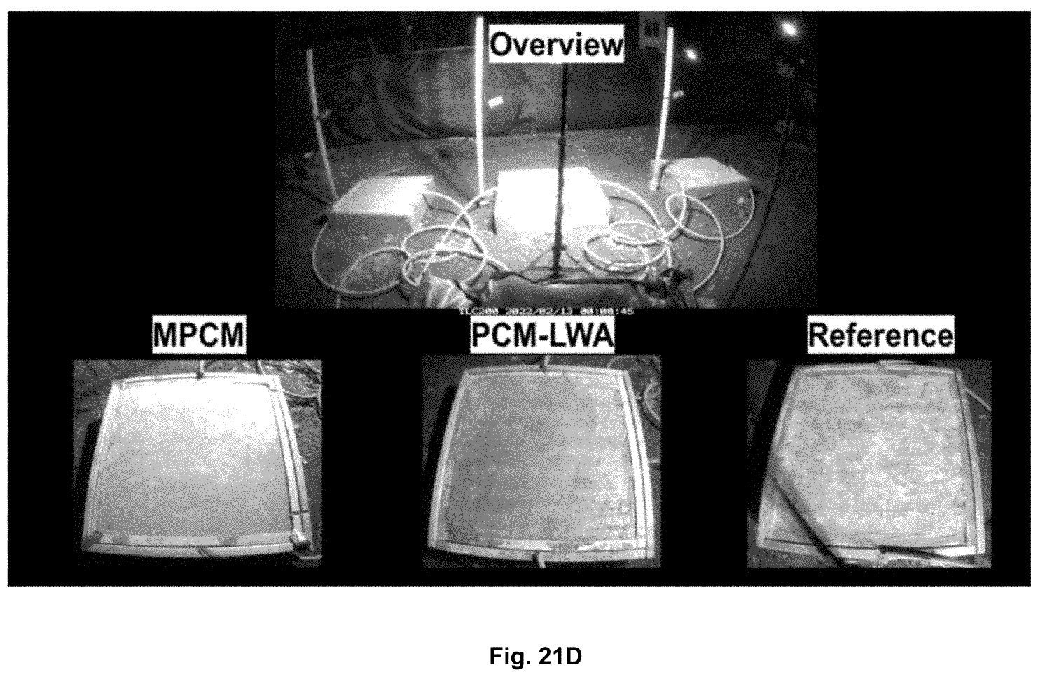

FIGS. 21A-21D illustrate a large-scale slab deicing testing of various concrete slabs. FIG. 21A and 21D illustrate a test setup with a PCM-LWA concrete slab, a MPCM concrete slab, and a reference slab. The mixtures of each are discussed in Example 2 (FIGS. 3, 5, 17). FIGS. 21B and 21C illustrate the top view (FIG. 21B) and cross-sectional view (FIG. 21C) of the concrete slabs illustrated in FIGS. 21A and 21D.

Referring to the concrete slabs described in FIGS. 21A-21D, FIGS. 22A-22D illustrate a cross-sectional view of several layers of each tested concrete slab. FIG. 22A illustrates 5 layers of the tested concrete slabs (A, B, C, D, E), where each layer is of equal depth (e.g., about 2 inches). FIG. 22B illustrates a cross-sectional view of the reference concrete slab, FIG. 22C illustrates a cross-sectional view of the PCM-LWA concrete slab, and FIG. 22D illustrates a cross-sectional view of the MPCM concrete slab.

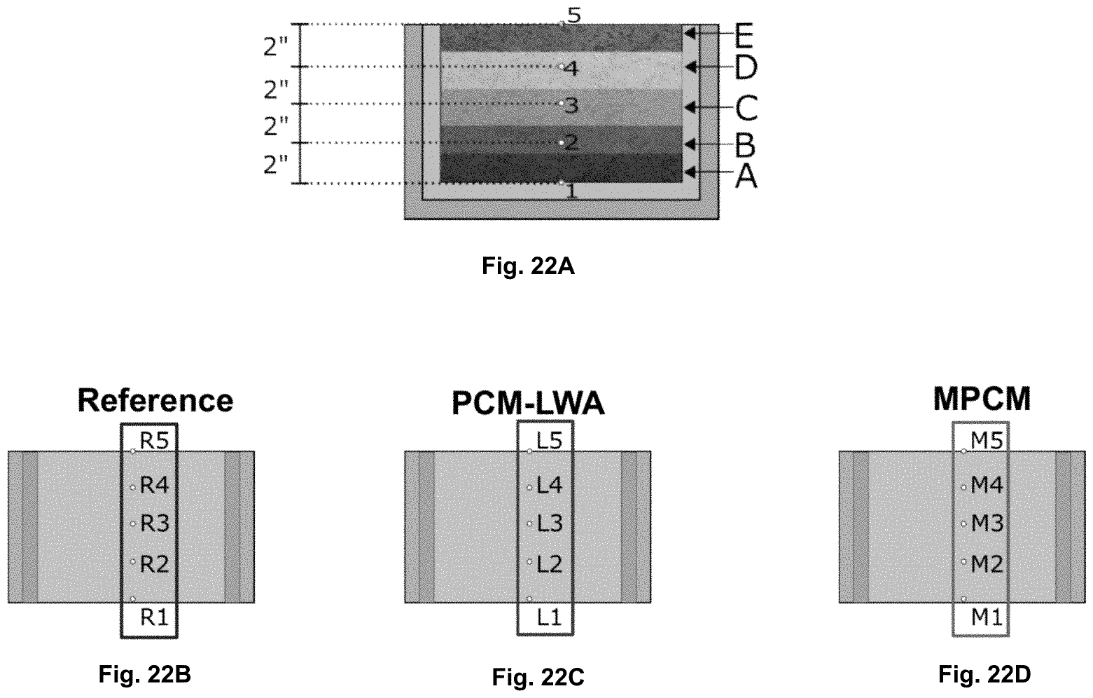

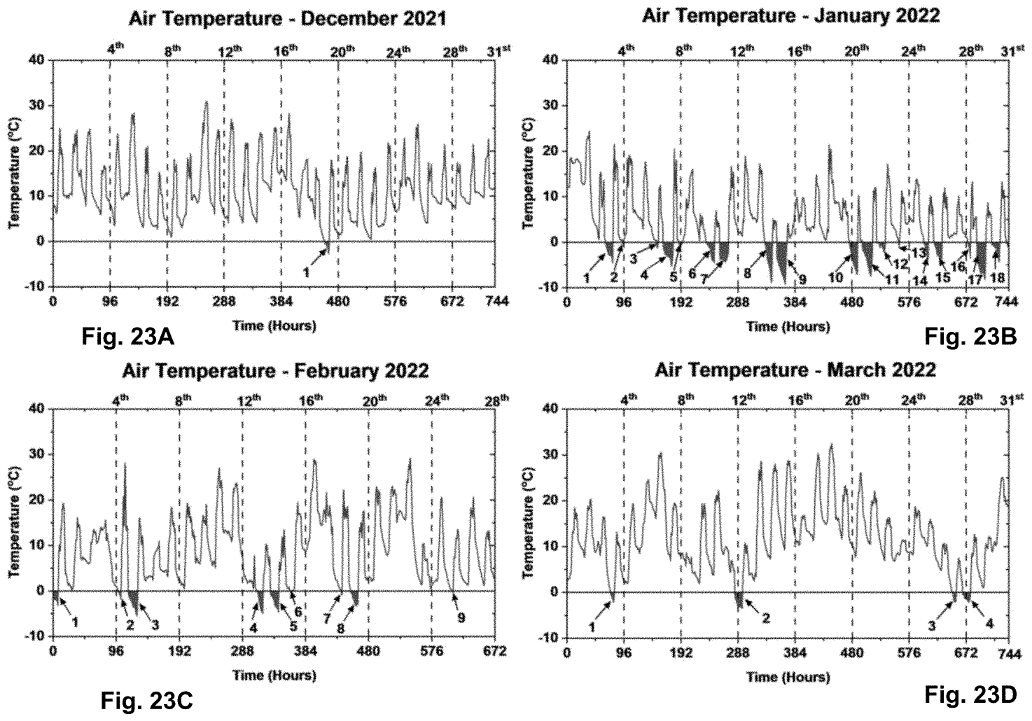

The thermal assessment testing of the above-referenced concrete slabs was conducted between December 2021 and March 2022. FIGS. 23A-23D illustrate the air temperature for each month, where FIG. 23A illustrates the air temperature for December 2021, FIG. 23B illustrates the air temperature for January 2022, FIG. 23C illustrates the air temperature for February 2022, and FIG. 23D illustrates the air temperature for March 2022.

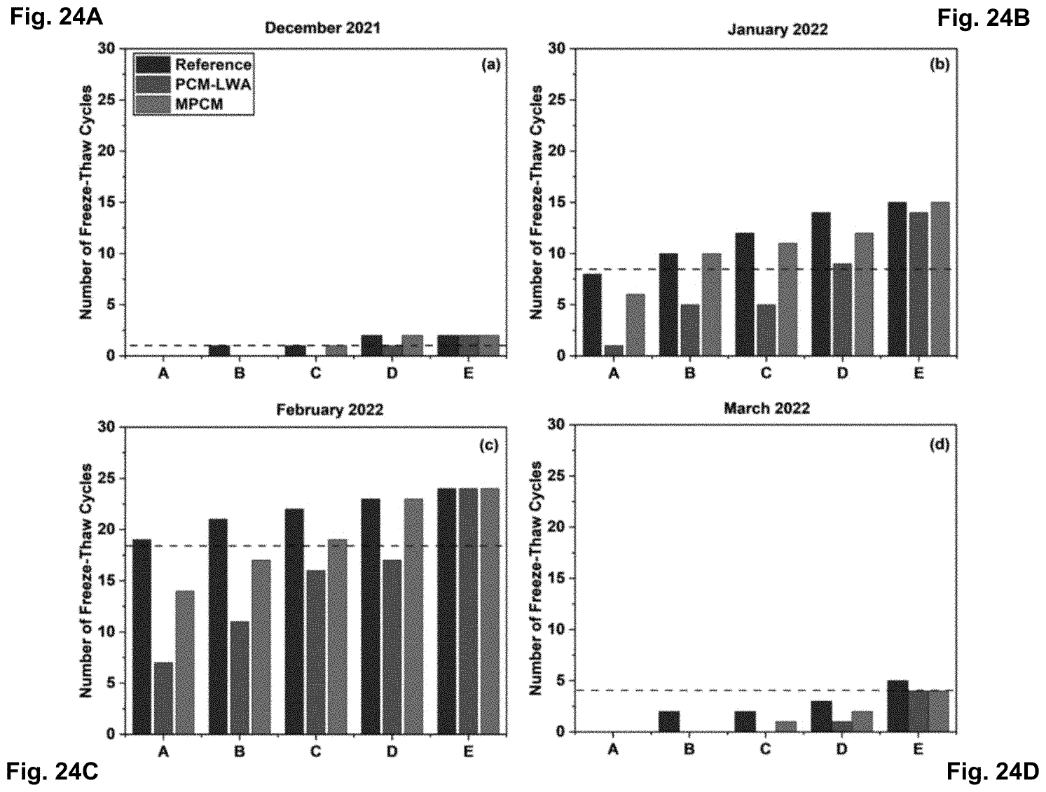

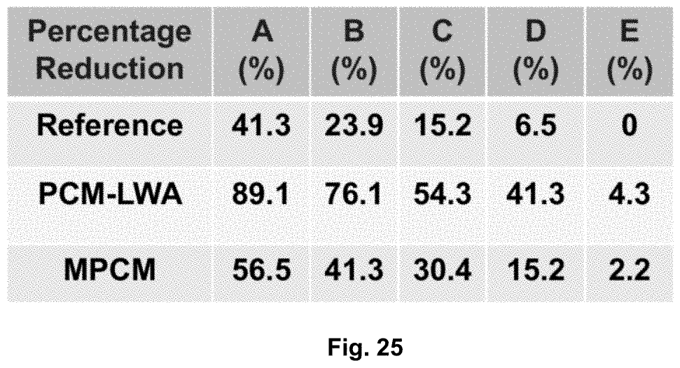

FIGS. 24A-24D illustrate the number of freeze-thaw cycles per month for each of the above-referenced concrete slabs, as it relates to the months outlined above. FIG. 24A illustrates the number of freeze-thaw cycles in December 2021, FIG. 24B illustrates the number of freeze-thaw cycles in January 2022, FIG. 24C illustrates the number of freeze-thaw cycles in February 2022, and FIG. 24D illustrates the number of freeze-thaw cycles in March 2022. FIG. 25 illustrates the percent reduction of the tested concrete slabs for each of the layers, where layer E is the outermost layer and layer A is the innermost layer.

The PCM-LWA concrete slab produced fewer freeze-thaw cycles each month versus the reference concrete slab and the MPCM concrete slab. The MPCM concrete slab produced fewer freeze-thaw cycles each month versus the reference concrete slab.

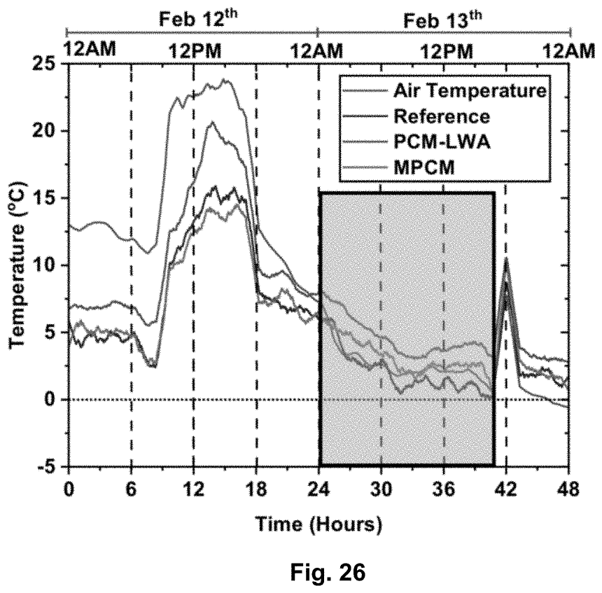

FIG. 26 illustrates the snow-melting performance over a 48-hour period where about 0.7 inches of snow fell on each of the tested concrete slabs. Based on the results, the PCM-LWA concrete slab maintained a positive temperature difference of about 2.42° C. for about 3 days. The MPCM concrete slab maintained a positive temperature difference of about 1.03° C. for about 3 days compared.

Based on the results, both PCM incorporation methods (LWA and MPCM) produced desirable thermal responses for freezing and thawing and snow melting applications, compared to the reference concrete slab. Moreover, PCM-LWA and MPCM concrete slabs exhibit exothermic heat releases over a longer period of time compared to the reference concrete slab during snowfall events, thereby enabling improved snow-melting.

### EXAMPLE 4

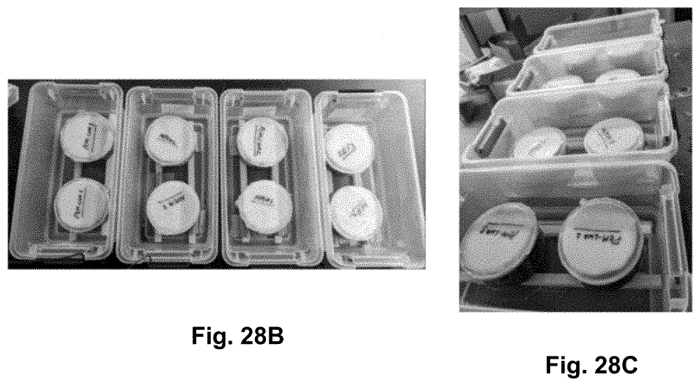

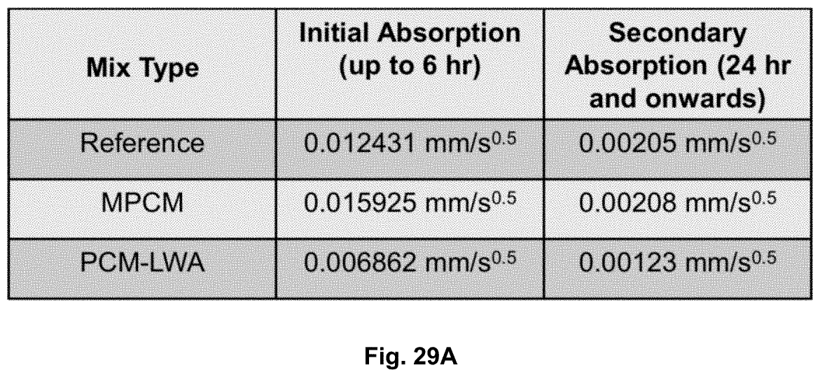

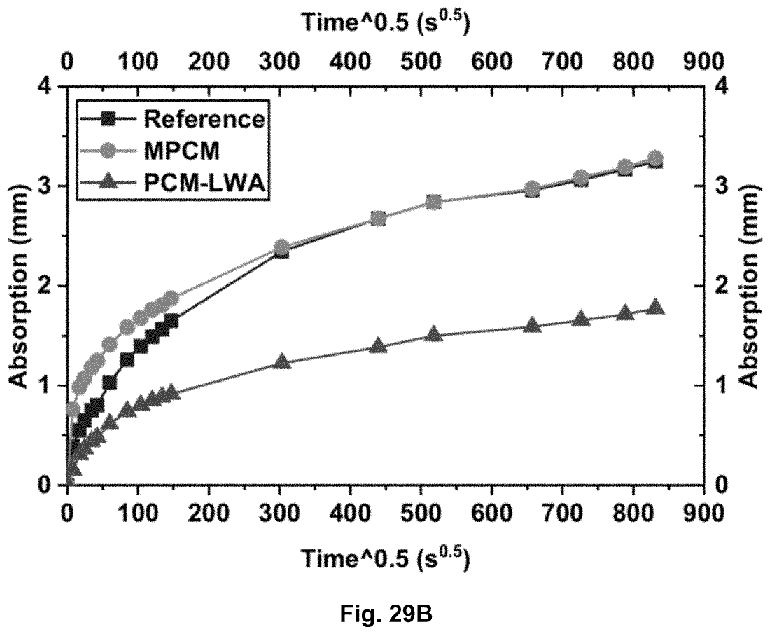

An exemplary experiment of the water absorption/sorptivity of PCM mixtures is discussed below and in reference to FIGS. 28A-29B. Water absorption of concrete depends, in part, on the proportions of the concrete mixture, the chemical admixtures and PCMs, entrained air content, curing age and type of curing, and presence of microcracks. In this experiment, 2 inches by 4 inches concrete specimens are environmentally conditioned at about 50+/−2° C. and about 23% relative humidity (RH) for about 72 hours. The specimens are then stored in a sealed container for about 15 days at about 23+/−2° C. prior to the experiment.

As shown in FIGS. 28A-28C, the concrete specimens, including the reference concrete mixture, MPCM mixture, and PCM-LWA mixture, as described herein, were set into water such that about 2+/−1 mm of water contacted the concrete specimens. Absorption was calculated using the below equation:

$$Absorption , 1 ( mm ) = \frac{{m}_{i} - {m}_{o}}{π {r}^{2} {ρ}_{water}}$$

FIGS. 29A and 29B illustrate the results of the tests. The initial MPCM sorptivity is about 28.1% higher than the reference and the PCM-LWA sorptivity is about 44.8% lower than the reference. The secondary MPCM sorptivity is about 1.6% higher than the reference and the PCM-LWA sorptivity is about 39.5% lower than the reference.

The following clauses further define particular aspects and embodiments of the present disclosure.

Clause 1. A packaged phase change material for deicing including: a package defining an internal volume; and a deicing composition, wherein the deicing composition includes: a phase change material, and a deicing material.

Clause 2. The packaged phase change material for deicing according to clause 1, wherein the phase change material is incorporated with the deicing material in the amount of about 1% to about 99%. In some forms, the amount of phase change material incorporated with the deicing material is between 5% to about 80%, 7% to about 60%, 8 to about 55, 50, 45, 40, 35, 30, 25, 24, 23, 22, 21, 20, 19, 18, 17, 16, or 15%. In some instances the amount of phase change material is determined by the specific salt or deicing composition utilized. In some forms, the phase change material is present in an amount between 5% and 25, 20, or 15%.

Clause 3. The packaged phase change material for deicing according to any of the proceeding clauses, wherein the phase change material is incorporated into the deicing composition as a granulated additive.

Clause 4. The packaged phase change material for deicing according to any of the proceeding clauses, wherein the phase change material is coated onto the deicing material.

Clause 5. The packaged phase change material for deicing according to any of the proceeding clauses, wherein the deicing composition further includes a lightweight aggregate, wherein the lightweight aggregate is impregnated with the phase change material.

Clause 6. The packaged phase change material for deicing according to any of the proceeding clauses, wherein the package is selected from the group including bags, totes, railcars, supersacks, and any combination thereof.

Clause 7. The packaged phase change material for deicing according to any of the proceeding clauses, wherein the phase change material is selected from the group including paraffins, non-paraffin organics (ethylene glycol, formic acid), salt hydrates (sodium sulfate decahydrate, Dowtherm), metallics, fused salt eutectics, solid-solid, n-tetradecane, n-hexadecane, n-octadecane, n-pentadecane, n-Eicosane, polyethylene glycol 600, acetic acid, tristearin, myristic acid, stearic acid, elaidic acid, acetamide, methyl fumarate, oxazoline wax—TS-970, oxazoline wax—ES-254, sodium hydrogen phosphate dodecahydrate, lithium nitrate trihydrate, barium hydroxide octahydrate, and any combination thereof.

Clause 8. The packaged phase change material for deicing according to any of the proceeding clauses and further including an anti-caking agent, wherein the anti-caking agent is selected from the group comprising sodium aluminosilicate, sodium ferrocyanide, potassium ferrocyanide, calcium carbonate, magnesium carbonate, silicon dioxide (SiO2), stearates of calcium and magnesium, silica, talc, flour, starch, tricalcium phosphate, powdered cellulose, sodium bicarbonate, calcium ferrocyanide, calcium phosphate, sodium silicate, calcium silicate, magnesium trisilicate, potassium aluminum silicate, calcium aluminosilicate, bentonite, aluminum silicate, stearic acid, polydimethylsiloxane, and any combination thereof.

Clause 9. The packaged phase change material for deicing according to any of the proceeding clauses and further including a salt melt trigger, wherein the salt melt trigger is selected from the group comprising inorganic salts (a carbonate or an additional chloride such as potassium carbonate, lithium chloride, or magnesium chloride hexahydrate), an organic compound containing an ether group or a hydroxyl group, compounds with groups selected from the group consisting of saccharides, alcohols, glycols and glucosides, and any combination or mixture of the foregoing.

Clause 10. The packaged phase change material for deicing according to any of the proceeding clauses, wherein the deicer material is selected from the group including sodium chloride, calcium chloride, urea, magnesium chloride, potassium sulfate, lignin sulfonate, sodium sulfate, sodium silicates, NaCl, KCl, MgCl2, calcium magnesium acetate, and any combination thereof.

Clause 11. A concrete mixture including: a percentage of cement; a percentage of lightweight aggregate; a percentage of water; and a percentage of phase change material.

Clause 12. The concrete mixture according to clause 11, wherein the lightweight aggregate is impregnated with a percentage of the phase change material.

Clause 13. The concrete mixture according to clauses 11 and 12, wherein the phase change material is selected from the group including paraffins, non-paraffin organics (ethylene glycol, formic acid), salt hydrates (sodium sulfate decahydrate, Dowtherm), metallics, fused salt eutectics, solid-solid, n-tetradecane, n-hexadecane, n-octadecane, n-pentadecane, n-Eicosane, polyethylene glycol 600, acetic acid, tristearin, myristic acid, stearic acid, elaidic acid, acetamide, methyl fumarate, oxazoline wax—TS-970, oxazoline wax—ES-254, sodium hydrogen phosphate dodecahydrate, lithium nitrate trihydrate, barium hydroxide octahydrate, and any combination thereof.

Clause 14. The concrete mixture according to any of clauses 11-13, wherein the phase change material is incorporated with the lightweight aggregate in the amount of about 1% to about 99%. In some forms, the amount of phase change material incorporated with the deicing material is between 5% to about 80%, 7% to about 60%, 8 to about 55, 50, 45, 40, 35, 30, 25, 24, 23, 22, 21, 20, 19, 18, 17, 16, or 15%. In some instances the amount of phase change material is determined by the specific salt or deicing composition utilized. In some forms, the phase change material is present in an amount between 5% and 25, 20, or 15%.

Clause 15. The concrete mixture according to any of clauses 11-14, wherein the phase change material is configured to release stored energy as the phase change material begins to freeze, thereby heating a surface.

Clause 16. The concrete mixture according to any of clauses 11-15, wherein the phase change material is configured to leach a percentage of the phase change material into the concrete mixture when the concrete mixture is cured, thereby forming a thin coating on a surface of the cured concrete mixture.

Clause 17. A method of applying a deicing composition, wherein the deicing composition includes a phase change material, and a deicing material, the method including: applying the deicing composition to a porous surface, wherein the deicing composition is configured to release stored energy as the phase change material begins to freeze.

Clause 18. The method according to clause 17, wherein the phase change material is configured to leach a percentage of the phase change material into the porous surface to form a thin coating and repel water.

Clause 19. The method according to clauses 17 and 18, wherein the phase change material is selected from the group including paraffins, non-paraffin organics (ethylene glycol, formic acid), salt hydrates (sodium sulfate decahydrate, Dowtherm), metallics, fused salt eutectics, solid-solid, n-tetradecane, n-hexadecane, n-octadecane, n-pentadecane, n-Eicosane, polyethylene glycol 600, acetic acid, tristearin, myristic acid, stearic acid, elaidic acid, acetamide, methyl fumarate, oxazoline wax—TS-970, oxazoline wax—ES-254, sodium hydrogen phosphate dodecahydrate, lithium nitrate trihydrate, barium hydroxide octahydrate, and any combination thereof.

Clause 20. The according to any of clauses 17-19, wherein the phase change material is incorporated with the deicing material in the amount of about 1% to about 99%. In some forms, the amount of phase change material incorporated with the deicing material is between 5% to about 80%, 7% to about 60%, 8 to about 55, 50, 45, 40, 35, 30, 25, 24, 23, 22, 21, 20, 19, 18, 17, 16, or 15%. In some instances the amount of phase change material is determined by the specific salt or deicing composition utilized. In some forms, the phase change material is present in an amount between 5% and 25, 20, or 15%.

All documents cited herein and any below-listed documents, which may be attached hereto for submission with this provisional patent application, all referenced publications cited therein, and the descriptions and information contained in these documents are expressly incorporated herein by reference in their entirety to the same extent as if each document or cited publication/patent document were individually and expressly incorporated herein:

Spragg, R. P., Castro, J., Li, W., Pour-Ghaz, M., Huang, P. T., & Weiss, J. (2011). Wetting and drying of concrete using aqueous solutions containing deicing salts. Cement and Concrete Composites, 33(5), 535-542.

Sakulich, A. R., & Bentz, D. P. (2012). Incorporation of phase change materials in cementitious systems via fine lightweight aggregate. Construction and Building Materials, 35, 483-490.

Farnam, Y., Krafcik, M., Liston, L., Washington, T., Erk, K., Tao, B., & Weiss, J. (2016). Evaluating the use of phase change materials in concrete pavement to melt ice and snow. Journal of Materials in Civil Engineering, 28(4), 04015161.

Rathod, M. K., and Jyotirmay Banerjee. “Experimental investigations on latent heat storage unit using paraffin wax as phase change material.” Experimental heat transfer 27, no. 1 (2014): 40-55.

Faivre, C., Bellet, D., & Dolino, G. (1999). Phase transitions of fluids confined in porous silicon: A differential calorimetry investigation. The European Physical Journal B -Condensed Matter and Complex Systems, 7(1), 19-36.

Reid, D. S. (1997). Overview of physical/chemical aspects of freezing. In Quality in frozen food (pp. 10-28). Springer, Boston, MA.

Yan, X., Wang, T. B., Gao, C. F., & Lan, X. Z. (2013). Mesoscopic phase behavior of tridecane—tetradecane mixtures confined in porous materials: effects of pore size and pore geometry. The Journal of Physical Chemistry C, 117(33), 17245-17255.

Esmaeeli, H. S., Farnam, Y., Haddock, J. E., Zavattieri, P. D., & Weiss, W. J. (2018). Numerical analysis of the freeze- thaw performance of cementitious composites that contain phase change material (PCM). Materials & Design, 145, 74-87.

Althoey, F., & Farnam, Y. (2020). Performance of Calcium Aluminate Cementitious Materials in the Presence of Sodium Chloride. Journal of Materials in Civil Engineering, 32(10), 04020277.

Balapour, M., Mutua, A. W. and Farnam, Y., 2021. Evaluating the thermal efficiency of microencapsulated phase change materials for thermal energy storage in cementitious composites. Cement and Concrete Composites, 116, p.103891.

While the invention has been described with reference to preferred embodiments, it will be understood by those skilled in the art that various changes may be made, and equivalents may be substituted for the elements thereof without departing from the scope of the invention. In addition, many modifications may be made to adapt the teaching of the invention to particular use, application, manufacturing conditions, use conditions, composition, medium, size, and/or materials without departing from the essential scope and spirit of the invention. Therefore, it is intended that the invention is not limited to the exemplary embodiments and best mode contemplated for carrying out this invention as described herein. Since many modifications, variations, and changes in detail can be made to the described examples, it is intended that all matters in the preceding description and shown in the accompanying figures be interpreted as illustrative and not in a limiting sense.

1. A packaged phase change material for deicing comprising:
a. a package defining an internal volume; and
b. a deicing composition, wherein the deicing composition comprises:
i. a phase change material, and
ii. a deicing material.

2. The packaged phase change material for deicing according to claim 1, wherein the phase change material is incorporated with the deicing material in the amount of about 1% to about 99%.

3. The packaged phase change material for deicing according to claim 1, wherein the phase change material is incorporated into the deicing composition as a granulated additive.

4. The packaged phase change material for deicing according to claim 1, wherein the phase change material is coated onto the deicing material.

5. The packaged phase change material for deicing according to claim 1, wherein the deicing composition further comprises a lightweight aggregate, wherein the lightweight aggregate is impregnated with the phase change material.

6. The packaged phase change material for deicing according to claim 1, wherein the package is selected from the group comprising bags, totes, railcars, supersacks, and combinations thereof.

7. The packaged phase change material for deicing according to claim 1, wherein the phase change material is selected from the group comprising paraffins, non-paraffin organics (ethylene glycol, formic acid), salt hydrates (sodium sulfate decahydrate, Dowtherm), metallics, fused salt eutectics, solid-solid, n-tetradecane, n-hexadecane, n-octadecane, n-pentadecane, n-Eicosane, polyethylene glycol 600, acetic acid, tristearin, myristic acid, stearic acid, elaidic acid, acetamide, methyl fumarate, oxazoline wax—TS-970, oxazoline wax—ES-254, sodium hydrogen phosphate dodecahydrate, lithium nitrate trihydrate, barium hydroxide octahydrate, and combinations thereof.

8. The packaged phase change material for deicing according to claim 1 further comprising an anti-caking agent, wherein the anti-caking agent is selected from the group comprising sodium aluminosilicate, sodium ferrocyanide, potassium ferrocyanide, calcium carbonate, magnesium carbonate, silicon dioxide (SiO2), stearates of calcium and magnesium, silica, talc, flour, starch, tricalcium phosphate, powdered cellulose, sodium bicarbonate, calcium ferrocyanide, calcium phosphate, sodium silicate, calcium silicate, magnesium trisilicate, potassium aluminum silicate, calcium aluminosilicate, bentonite, aluminum silicate, stearic acid, polydimethylsiloxane, and combinations thereof.

9. The packaged phase change material for deicing according to claim 8 further comprising a salt melt trigger, wherein the salt melt trigger is selected from the group comprising inorganic salts (a carbonate or an additional chloride such as potassium carbonate, lithium chloride, or magnesium chloride hexahydrate), an organic compound containing an ether group or a hydroxyl group, compounds with groups selected from the group consisting of saccharides, alcohols, glycols and glucosides, and mixtures of the foregoing.

10. The packaged phase change material for deicing according to claim 1, wherein the deicer material is selected from the group comprising sodium chloride, calcium chloride, urea, magnesium chloride, potassium sulfate, lignin sulfonate, sodium sulfate, sodium silicates, NaCl, KCl, MgCl2, calcium magnesium acetate, and combinations thereof.

11. A concrete mixture comprising:
a percentage of cement;
a percentage of lightweight aggregate;
a percentage of water; and
a percentage of phase change material.

12. The concrete mixture according to claim 11, wherein the lightweight aggregate is impregnated with a percentage of the phase change material.

13. The concrete mixture according to claim 11, wherein the phase change material is selected from the group comprising paraffins, non-paraffin organics (ethylene glycol, formic acid), salt hydrates (sodium sulfate decahydrate, Dowtherm), metallics, fused salt eutectics, solid-solid, n-tetradecane, n-hexadecane, n-octadecane, n-pentadecane, n-Eicosane, polyethylene glycol 600, acetic acid, tristearin, myristic acid, stearic acid, elaidic acid, acetamide, methyl fumarate, oxazoline wax—TS-970, oxazoline wax—ES-254, sodium hydrogen phosphate dodecahydrate, lithium nitrate trihydrate, barium hydroxide octahydrate, and combinations thereof.

14. The concrete mixture according to claim 11, wherein the phase change material is incorporated with the lightweight aggregate in the amount of about 1% to about 99%.

15. The concrete mixture according to claim 11, wherein the phase change material is configured to release stored energy as the phase change material begins to freeze, thereby heating a surface.

16. The concrete mixture according to claim 11, wherein the phase change material is configured to leach a percentage of the phase change material into the concrete mixture when the concrete mixture is cured, thereby forming a thin coating on a surface of the cured concrete mixture.

17. A method of applying a deicing composition, wherein the deicing composition comprises a phase change material, and a deicing material, the method comprising:
applying the deicing composition to a porous surface, wherein the deicing composition is configured to release stored energy as the phase change material begins to freeze.

18. The method according to claim 17, wherein the phase change material is configured to leach a percentage of the phase change material into the porous surface to form a thin coating and repel water.

19. The method according to claim 17, wherein the phase change material is selected from the group comprising paraffins, non-paraffin organics (ethylene glycol, formic acid), salt hydrates (sodium sulfate decahydrate, Dowtherm), metallics, fused salt eutectics, solid-solid, n-tetradecane, n-hexadecane, n-octadecane, n-pentadecane, n-Eicosane, polyethylene glycol 600, acetic acid, tristearin, myristic acid, stearic acid, elaidic acid, acetamide, methyl fumarate, oxazoline wax—TS-970, oxazoline wax—ES-254, sodium hydrogen phosphate dodecahydrate, lithium nitrate trihydrate, barium hydroxide octahydrate, and combinations thereof.

20. The according to claim 17, wherein the phase change material is incorporated with the deicing material in the amount of about 1% to about 99%.
